(19) United States
(12) Patent Application Publication
(10) Pub. No.: US 2012/0308952 A1
(43) Pub. Date: Dec. 6, 2012

(54) PRESCRIPTION-ALTERING ACCESSORIES FOR ORTHODONTIC BRACKETS, AND ORTHODONTIC BRACKET ASSEMBLIES INCLUDING THE SAME

(76) Inventor: Christopher C. Cosse, Shreveport, LA (US)

(21) Appl. No.: 13/486,234

(22) Filed: Jun. 1, 2012

Related U.S. Application Data
(60) Provisional application No. 61/492,420, filed on Jun. 2, 2011.

(51) Int. Cl. A61C 7/02; A61C 7/12

(52) U.S. Cl. 433/3; 433/24

(57) ABSTRACT

Prescription-altering accessories for use with orthodontic brackets to modify the corrective forces applied to the teeth by orthodontic bracket assemblies that include the orthodontic bracket. The orthodontic bracket assemblies may include specialized orthodontic brackets that are designed and/or configured for use with the prescription-altering accessories. Additionally or alternatively, the orthodontic bracket assemblies may be configured for use with traditional orthodontic brackets, such as by being operatively attached thereto. The prescription-altering accessories may be configured to generate a modifying force to alter any suitable tip, torque, rotation, and/or step corrective force that may be applied to one or more teeth within a dental arch to improve, or otherwise modify, the occlusion of the one or more teeth. The prescription-altering accessories may be configured to alter the corrective force without removal and/or modification of an installed archwire and/or without removal and/or replacement of installed orthodontic brackets.

### RELATED APPLICATION

This application claims priority to U.S. Provisional Patent Application Ser. No. 61/492,420, which was filed on Jun. 2, 2011, and the complete disclosure of which is hereby incorporated by reference.

### FIELD OF THE DISCLOSURE

The present disclosure is directed generally to orthodontic appliances, and more specifically to prescription-altering accessories for orthodontic brackets and orthodontic bracket assemblies containing the same.

### BACKGROUND OF THE DISCLOSURE

Orthodontic appliances, which also may be referred to herein as orthodontic bracket assemblies, are devices that may be utilized to modify a position of a patient's teeth, such as to change the alignment, or occlusion, of the teeth. Orthodontic appliances may include a variety of components, including one or more orthodontic brackets and an archwire.

Orthodontic brackets are typically small, slotted devices for use during orthodontic treatment. The brackets usually are configured to be attached, or operatively secured, to the front surfaces of teeth, either by directly cementing the bracket to a tooth surface or by bonding the bracket to a metal band that encircles the tooth, though they also may be attached to the back surfaces of teeth. The slots in the brackets, which may be referred to herein as archwire slots and/or archwire passages, are disposed horizontally, or generally horizontally, and are configured to receive an archwire.

Traditionally, an archwire is a resilient piece of wire that may be bent or twisted prior to installation in the archwire slot, with an archwire typically extending through the archwire slots of all of the orthodontic brackets that are attached to a patient's upper or lower teeth. The engagement between the archwire and the brackets creates corrective, or prescriptive, forces that are directed to the teeth by the orthodontic brackets to urge the teeth into a correct, or desired, alignment, or occlusion.

During the course of an orthodontic treatment, it may be desirable to change, modify, or otherwise alter the prescription, or the corrective forces, that one or more of the orthodontic brackets applies to one or more of the teeth to which the brackets are attached. Conventionally, this change in corrective forces may be accomplished through removal of the archwire from the archwire slots of all of the respective brackets through which the archwire extends, bending the same or a new archwire to provide the desired magnitude and direction of corrective forces, and installing the archwire in the respective brackets. The removal and (re)installation of the archwire typically requires respective release and securing of ligatures that are used to secure the archwire in the archwire slots of the orthodontic brackets. Additionally or alternatively, this change in corrective forces may be accomplished through removal and repositioning and/or replacement of one or more of the brackets. While these methods may be effective at changing the corrective forces that are applied to a patient's teeth in order to produce the desired magnitude and direction of corrective forces, they may be time-consuming, uncomfortable for the patient, and/or require a significant level of skill and training in order to be performed accurately and efficiently.

### SUMMARY OF THE DISCLOSURE

Prescription-altering accessories for use with orthodontic brackets to modify the corrective forces applied to the teeth by orthodontic bracket assemblies that include the orthodontic bracket. The prescription-altering accessories may include the use of specialized orthodontic brackets that are designed and/or configured for use with the prescription-altering accessories. Additionally or alternatively, the prescription-altering accessories may be configured for use with traditional orthodontic brackets, such as by being operatively attached thereto. The prescription-altering accessories may be configured to alter any suitable tip, torque, rotation, and/or step corrective force that may be applied to one or more teeth within a dental arch to modify the prescription of the orthodontic bracket to improve, or otherwise modify, the occlusion of the one or more teeth. The prescription-altering accessories may be configured to alter the corrective force without removal and/or modification of an installed archwire and/or without removal and/or replacement of installed orthodontic brackets that are operatively secured to the archwire.

In some embodiments, prescription-altering accessories according to the present disclosure may include shim-based prescription-altering accessories that utilize a prescription-altering shim. The prescription-altering shim may be configured to be inserted into a traditional orthodontic bracket, such as into the archwire slot thereof, to generate the modifying force and alter the orthodontic prescription that otherwise would be provided by the orthodontic bracket when the archwire is received and secured therein.

In some embodiments, shim-based prescription-altering accessories according to the present disclosure may include an orthodontic bracket that includes a designated prescription-altering shim receptacle that is configured for use with the prescription-altering shim. The prescription-altering shim receptacle may be configured to accept the prescription-altering shim and to selectively change, or modify, one or more corrective force that otherwise would be applied to a tooth by the bracket and archwire if the shim was not present.

In some embodiments, prescription-altering accessories according to the present disclosure may include a prescription-altering cap, or cover, that is configured to be operatively attached to the orthodontic bracket assembly. The prescription-altering cap may operate in a manner that is similar to that of the shim-based prescription-altering accessories to generate a modifying force that alters the corrective force that is applied to one or more teeth by the orthodontic bracket assembly.

### BRIEF DESCRIPTION OF THE DRAWINGS

FIG. 1 is a schematic representation of illustrative, non-exclusive examples of a dental arch that includes a plurality of teeth, as viewed from the occlusal plane.

FIG. 2 is a schematic representation of illustrative, non-exclusive examples of a portion of a dental arch, as viewed from the buccal, labial, or lingual direction.

FIG. 3 is a schematic representation of illustrative, non-exclusive examples of a cross section of a dental arch, as viewed from the buccolingual plane.

FIG. 4 is a schematic representation of illustrative, non-exclusive examples of a portion of a dental arch that includes an orthodontic bracket assembly according to the present disclosure, as viewed from the buccal, labial, or lingual direction.

FIG. 5 is a schematic fragmentary representation of an illustrative, non-exclusive example of an orthodontic bracket assembly that includes a prescription-altering shim according to the present disclosure and in which the prescription-altering shim is removed from a prescription-altering shim receptacle.

FIG. 6 is another schematic fragmentary representation of an illustrative, non-exclusive example of an orthodontic bracket assembly that includes a prescription-altering shim according to the present disclosure and in which the prescription-altering shim is present within the prescription-altering shim receptacle.

FIG. 7 is a schematic representation of illustrative, non-exclusive examples of a tooth including an orthodontic bracket assembly that includes a plurality of prescription-altering shim receptacles according to the present disclosure, as viewed from the buccal, labial, or lingual direction.

FIG. 8 is another schematic representation of illustrative, non-exclusive examples of a tooth including an orthodontic bracket assembly that includes a plurality of prescription-altering shim receptacles according to the present disclosure, as viewed from the occlusal plane.

FIG. 9 is another schematic representation of illustrative, non-exclusive examples of a tooth including an orthodontic bracket assembly that includes a prescription-altering shim receptacle according to the present disclosure, as viewed from the buccolingual plane.

FIG. 10 is a schematic representation of illustrative, non-exclusive examples of an orthodontic bracket assembly with an archwire slot that includes an archwire and defines a portion of a prescription-altering shim receptacle according to the present disclosure, wherein a prescription-altering shim may be inserted parallel to the archwire.

FIG. 11 is another schematic representation of illustrative, non-exclusive examples of an orthodontic bracket assembly with an archwire slot that includes an archwire and defines a portion of a prescription-altering shim receptacle according to the present disclosure, wherein a prescription-altering shim may be inserted parallel to the archwire.

FIG. 12 is another schematic representation of illustrative, non-exclusive examples of an orthodontic bracket assembly with an archwire slot that includes an archwire and a prescription-altering shim receptacle and prescription-altering shim according to the present disclosure, wherein the prescription-altering shim is inserted perpendicular to the archwire and may include one or more retention structures.

FIG. 13 is a schematic representation of illustrative, non-exclusive examples of an orthodontic bracket assembly that includes a prescription-altering shim that includes a shim body and an extension region according to the present disclosure.

FIG. 14 is a perspective view of less schematic but still illustrative, non-exclusive examples of an orthodontic bracket assembly that includes a prescription-altering shim receptacle and a prescription-altering shim according to the present disclosure.

FIG. 15 is a plan view of the orthodontic bracket assembly of FIG. 14.

FIG. 16 is a fragmentary elevation view of the orthodontic bracket assembly of FIG. 14.

FIG. 17 is a schematic representation of illustrative, non-exclusive examples of a tooth including an orthodontic bracket assembly that includes a bracket body and a prescription-altering cap according to the present disclosure, as viewed from the buccolingual plane.

FIG. 18 is another schematic representation of illustrative, non-exclusive examples of a tooth including an orthodontic bracket assembly that includes an orthodontic bracket and a prescription-altering cap according to the present disclosure, as viewed from the buccal, labial or lingual direction.

FIG. 19 is a side view of illustrative, non-exclusive examples of the prescription-altering cap of FIG. 18.

FIG. 20 is a back view of illustrative, non-exclusive examples of the prescription-altering cap of FIG. 18.

FIG. 21 is a flowchart depicting methods according to the present disclosure of altering a corrective force that is applied to a tooth by an orthodontic bracket assembly using a prescription-altering shim.

FIG. 22 is a flowchart depicting methods according to the present disclosure of altering a corrective force that is applied to a tooth by an orthodontic bracket assembly using a prescription-altering cap.

### DETAILED DESCRIPTION AND BEST MODE OF THE DISCLOSURE

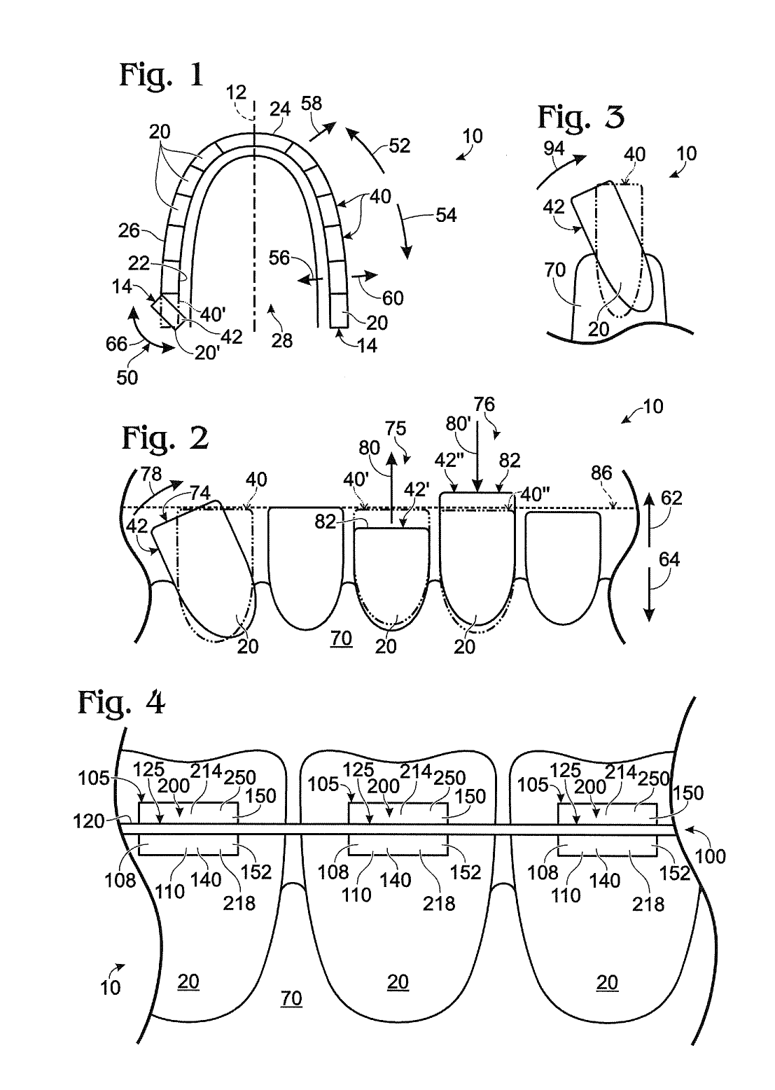

FIG. 1 is a schematic representation of illustrative, non-exclusive examples of a dental arch 10 including a plurality of teeth 20, as viewed from the occlusal plane. Each of the teeth includes a lingual surface 22 (a surface that faces the tongue), as well as labial surfaces 24 (surfaces that face the lips) or buccal surfaces 26 (surfaces that face the cheek).

Teeth 20 may include a correct, or desired, occlusion, alignment, and/or position, as illustrated schematically at 40, such as when the teeth are uniformly aligned within the corresponding dental arch, as well as an incorrect or undesired occlusion, alignment, and/or position, which also may be referred to as a malocclusion, a malocclusion state, and/or a maloccluded state, as illustrated schematically at 42. For example, a malocclusion may exist when the teeth are not uniformly aligned within the dental arch. When teeth 20 include a malocclusion, a corrective force 50 may be applied by an orthodontic appliance, which also may be referred to herein as an orthodontic bracket assembly, in order to move, adjust, or otherwise urge the teeth into a more desired occlusion.

Corrective forces 50 may be applied in any suitable direction in order to move a maloccluded tooth to a desired occlusion. This may include applying corrective forces in a mesial direction 52 (i.e., toward midline 12 of dental arch 10), in a distal direction 54 (i.e., away from midline 12 and toward a last tooth 14 in each quadrant of dental arch 10), in a lingual direction 56 (i.e., toward tongue 28), and/or in a labial direction 58 or buccal direction 60 (i.e., away from the tongue and toward the lips or cheek, respectively). In addition, and as discussed in more detail herein, corrective forces also may be applied in a gingival direction (i.e., toward the gums) and/or in an occlusal direction (i.e., away from the gums and toward a biting surface of the tooth).

Corrective forces 50 may include any desired force or combination of forces, including tip, torque, rotation, and/or step forces, which may be applied to change the angulation, inclination, rotation, height and/or location of the tooth in order to move the tooth toward the desired occlusion. As used herein, tipping forces refer to applied forces that move the crown of the tooth in the mesiodistal direction. Thus, tipping forces may impact angulation. As used herein, torsional forces refer to forces applied to the tooth by an archwire that is in torsion within the archwire passage. Thus, torsional forces tend to move the crown of the tooth in the buccolingual directions and may impact inclination. As used herein, rotational forces refer to applied forces that tend to rotate the tooth about its long, or longitudinal, axis. As used herein, step forces refer to applied forces that do not tend to change the angulation, inclination, and/or rotation of the tooth but that instead tend to translate the entire tooth in a given direction. As an illustrative, non-exclusive example, and with continued reference to FIG. 1, a rotational corrective force 66 may be applied to tooth 20′ in order to move the tooth from maloccluded alignment 42 to a desired occlusion 40′ (as shown in dash-dot-dot lines).

FIG. 2 is a schematic representation of illustrative, non-exclusive examples of a portion of a dental arch 10, as viewed from the buccal, labial, or lingual direction. FIG. 2 illustrates that portions of teeth 20 are surrounded by the gingiva, or gums, 70. FIG. 2 also illustrates several malocclusions, as well as the corrective forces that may be utilized to move the maloccluded teeth to a more desired occlusion.

A tooth with an undesirable angulation, or alignment within the mesiodistal direction, is shown schematically at 74. Tooth 74 may be urged from maloccluded state 42 to desired occlusion 40 through the application of tipping force 78. A tooth 20 with undesirable alignment within the occlusal-gingival direction is shown schematically at 75. As shown in FIG. 2, application of step force 80 may move crown 82 of tooth 75 in occlusal direction 62 and toward occlusal plane 86. This may move the tooth from maloccluded state 42′ to desired occlusion 40′. Another tooth 20 with undesirable alignment within the occlusal-gingival direction is shown schematically at 76. Application of step force 80′ may move crown 82 of tooth 76 in gingival direction 64 and toward occlusal plane 86. This may move the tooth from maloccluded state 42″ to desired occlusion 40″.

FIG. 3 is a schematic representation of illustrative, non-exclusive examples of a cross section of a dental arch 10, including tooth 20 and gums 70, as viewed from the buccolingual plane. In FIG. 3, tooth 20 includes an undesirable inclination, or alignment, within the buccolingual direction. Application of torque force 94 may urge tooth 20 from maloccluded state 42 to desired occlusion 40.

FIG. 4 is a schematic representation of illustrative, non-exclusive examples of a portion of a dental arch 10 that includes a plurality of teeth 20 and gums 70, as viewed from the buccal, labial, or lingual direction. One or more teeth 20 include an orthodontic bracket assembly 100 according to the present disclosure operatively secured thereto. Orthodontic bracket assembly 100 includes one or more orthodontic brackets 105, which may be operatively secured to respective teeth 20 and include one or more archwire slots 125 that are sized, oriented, and/or otherwise configured to receive an archwire 120 therein, and one or more prescription-altering accessories 200. The orthodontic bracket assembly may include, be in mechanical communication with, and/or work in cooperation with, archwire 120. When archwire 120 is received and operatively secured within archwire slots 125, such as by a ligating structure 108, orthodontic brackets 105 may provide, apply, and/or supply corrective forces to teeth 20 to modify the occlusion, alignment, and/or position thereof.

As used herein, the phrase “operatively secured,” which also may be referred to herein as “operatively attached,” indicates that a first component is mechanically coupled, secured, and/or attached to a second component in any suitable manner. This may include direct and/or indirect coupling, securing, and/or attaching of the first component to the second component. As an illustrative, non-exclusive example, orthodontic brackets 105 may be secured directly to teeth 20, such as by being adhered thereto. As another illustrative, non-exclusive example, orthodontic brackets 105 may be indirectly secured to teeth 20, such as by being secured to metallic bands that encircle and/or are adhered to teeth 20. As yet another illustrative, non-exclusive example, archwire 120 may be secured within archwire slots 125 using a ligating structure 108.

Orthodontic bracket 105 includes an archwire slot 125 and may include any suitable structure that is configured to be operatively secured to a tooth 20. Orthodontic bracket 105 is configured to transfer corrective forces from archwire 120 to teeth 20 when the archwire is operatively secured within the archwire slot. As an illustrative, non-exclusive example, orthodontic bracket 105 may include a ligating orthodontic bracket 110 and/or a self-ligating orthodontic bracket 140.

As another illustrative, non-exclusive example, orthodontic bracket 105 may include a bracket body 150 and/or a bracket base 152. Bracket body 150 defines a portion of archwire slot 125. Bracket base 152, which also may be referred to herein as a base 152 and/or a base assembly 152, may be configured to be operatively secured to tooth 20 and to transfer the corrective force from archwire 120 to the tooth to which orthodontic bracket 105 is operatively secured. It is within the scope of the present disclosure that orthodontic bracket 105 and/or bracket body 150 thereof may include a one-piece, or monolithic, orthodontic bracket 105 and/or a one-piece, or monolithic, bracket body 150. Alternatively, it is also within the scope of the present disclosure that orthodontic bracket 105 and/or bracket body 150 thereof may include a plurality of components that are operatively secured to one another to form the orthodontic bracket.

As discussed in more detail herein, orthodontic bracket assemblies 100 according to the present disclosure further may include and/or be operatively secured to one or more prescription-altering accessories 200. As an illustrative, non-exclusive example, orthodontic brackets 105 may include one or more prescription-altering shim receptacles 218, which also may be referred to herein as shim receptacles 218 and/or receptacles 218, each of which is sized, oriented, and/or configured to receive a prescription-altering shim 214, which also may be referred to herein as a shim 214 and/or as an orthodontic shim 214. Accordingly, it is within the scope of the present disclosure that orthodontic bracket 105 may include a single shim receptacle, a plurality of interconnected shim receptacles, a plurality of spaced-apart shim receptacles, and/or a plurality of discrete shim receptacles. Additionally or alternatively, orthodontic brackets 105 may include and/or be operatively secured to one or more prescription-altering caps 250.

Illustrative, non-exclusive examples of orthodontic bracket assemblies 100, orthodontic brackets 105, and/or archwires 125 are disclosed in U.S. Pat. Nos. 6,302,688, 6,582,226, 4,597,739, 4,878,840, 3,772,787, 4,248,588, 4,492,573, 4,614,497, 4,698,017, 1,280,628, 1,821,171, 3,435,527, 6,659,766, 6,655,957, 6,358,045, 6,193,508, 5,857,850, 5,711,666, 5,562,444, 5,322,435, 5,094,614, 4,559,012, 4,531,911, 4,492,573, 4,419,078, 4,371,337, 4,077,126, 4,144,642, 4,248,588, 4,698,017, 3,772,787, 4,559,012, 4,561,844, 4,655,708, 4,197,642, 4,712,999, 4,171,568, 7,819,660, 7,771,640, and 6,632,088, as well as in U.S. Patent Application Publication No. 2011/0183280, the complete disclosures of which are hereby incorporated by reference. The structures, features, applications, and methods of the above-identified references may be utilized with and/or incorporated into orthodontic brackets and bracket assemblies according to the present disclosure to the extent that doing so does not conflict with the express provisions of the instant disclosure.

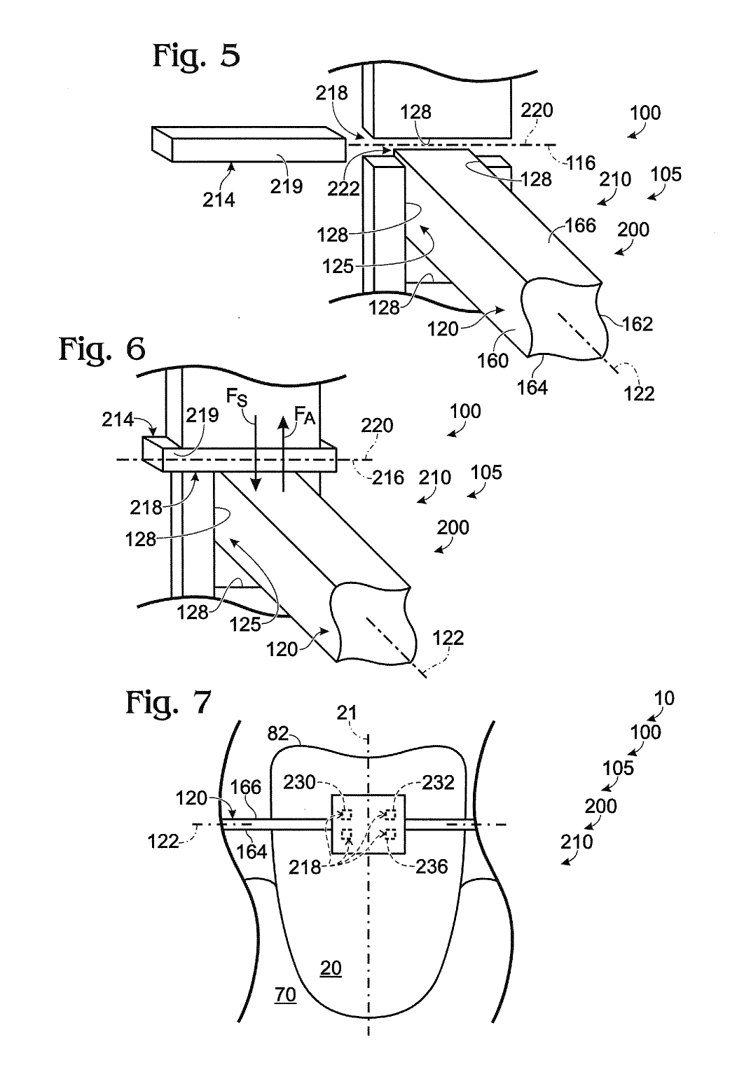

FIGS. 5-20 provide less schematic but still illustrative, non-exclusive examples of the orthodontic bracket assemblies and/or the prescription-altering accessories of FIG. 4. In FIGS. 4-20, like components are labeled with like numbers, and some components may not be discussed in detail herein with reference to each of FIGS. 4-20. Similarly, all components may not be labeled in each of FIGS. 4-20. However, it is within the scope of the present disclosure that any disclosed component may be utilized with and/or form a portion of any orthodontic bracket assembly 100 and/or prescription-altering accessory 200 that is disclosed herein. Additionally or alternatively, it is also within the scope of the present disclosure that a given component, while illustrated in a particular Figure, may not be included and/or required in all embodiments thereof.

FIGS. 5-16 provide illustrative, non-exclusive examples of orthodontic brackets and prescription-altering accessories 200 in the form of shim-based prescription-altering accessories 210 that may utilize or include a shim 214 to generate a modifying force that alters a corrective force that is applied to the tooth to which the bracket is attached. In other words, shim 214 is configured to modify the prescription, or corrective force, that otherwise would be applied to a tooth by a bracket, and/or bracket assembly with an operatively secured archwire. Shim 214 may additionally or alternatively be referred to herein as a pin, spacer, blade, and/or wedge, such as depending upon user preferences, the particular construction, shape, and/or use of the particular shim, etc.

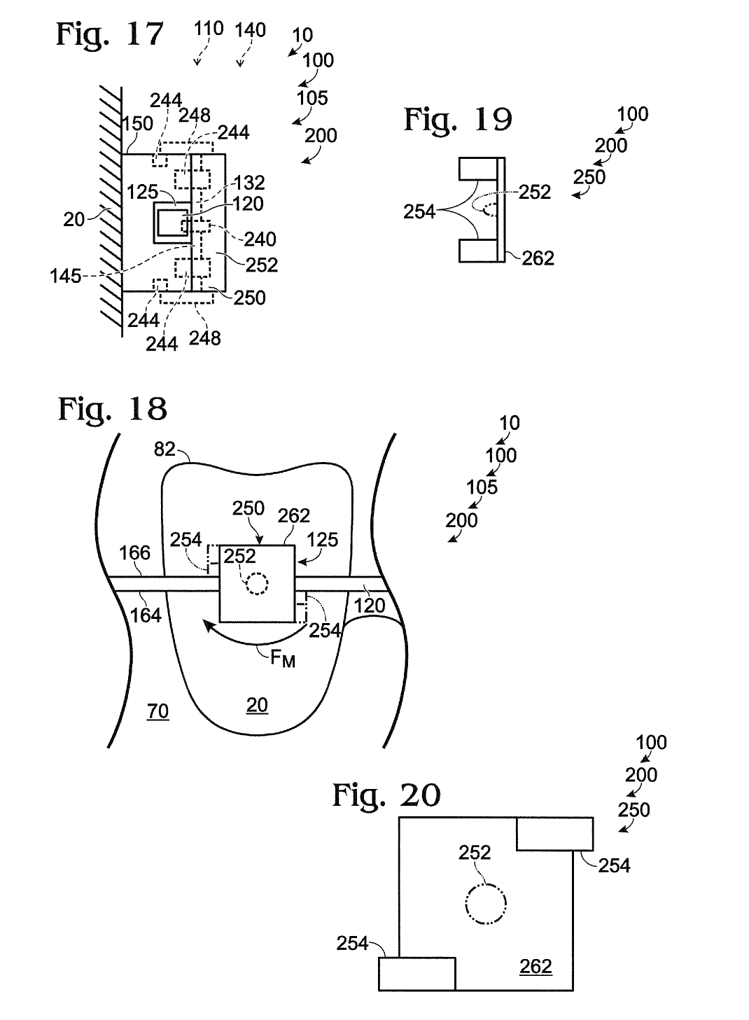

FIGS. 17-20 provide illustrative, non-exclusive examples of prescription-altering accessories 200 in the form of prescription-altering caps 250 that are configured to be received by any suitable orthodontic bracket and/or bracket body thereof (such as, but not limited to, the brackets 105 and bracket bodies 150 described, illustrated, and/or incorporated herein) that is operatively attached to a tooth. This may include a specialized, or dedicated orthodontic bracket 105 and/or bracket body 150 that is designed, configured, and/or selected for use with prescription-altering caps 250, as well as any other suitable orthodontic bracket, ligating orthodontic bracket, and/or self-ligating orthodontic bracket. Similar to shim-based prescription-altering accessories 210, prescription-altering caps 250 may be used to generate a modifying force that alters a corrective force that is applied to the tooth to which the bracket is attached.

FIGS. 5-6 are schematic, partial-fragmentary, representations of illustrative, non-exclusive examples of an orthodontic bracket assembly 100 that includes a prescription-altering accessory 200 in the form of a shim-based prescription-altering accessory 210 according to the present disclosure. Shim-based prescription-altering accessory 210 includes a shim 214 and a shim receptacle 218. Shim receptacle 218 is configured to receive shim 214 and may form a portion of orthodontic bracket 105. In FIG. 5, shim 214 is not received within shim receptacle 218. In contrast, FIG. 6 illustrates orthodontic bracket assembly 100 with shim 214 received within shim receptacle 218.

Shim 214 may include and/or be an elongate shim that includes a long, or longitudinal, axis, or direction, 216. Similarly, shim receptacle 218 may include and/or be an elongate shim receptacle that is configured to receive the elongate shim and includes a long, or longitudinal axis, or direction, 220. In addition, archwire 120 may include a long, or longitudinal, axis, or direction 122 that is defined by a portion of the archwire that is received within archwire slot 125. As discussed in more detail herein, longitudinal axis 216 of shim 214 and/or longitudinal axis 220 of shim receptacle 218 may be oriented at any suitable angle with respect to archwire 120, orthodontic bracket 105, and/or the tooth.

As an illustrative, non-exclusive example, and as discussed in more detail herein with reference to FIGS. 7 and 9, tooth 20 may define a long, or longitudinal, axis, or direction 21, and long axis 216 of shim 214 and/or long axis 220 of receptacle 218 may be within a threshold angle of being perpendicular to, or may be perpendicular to, long axis 21 of tooth 20. As another illustrative, non-exclusive example, and as discussed in more detail herein with reference to FIG. 8, long axis 216 of shim 214 and/or long axis 220 of receptacle 218 may be within a threshold angle of being parallel to, or may be parallel to, long axis 21 of tooth 20. As another illustrative, non-exclusive example, and as discussed in more detail herein with reference to FIGS. 7-8, long axis 216 of shim 214 and/or long axis 220 of receptacle 218 may be within a threshold angle of being perpendicular to, or may be perpendicular to, long axis 122 of archwire 120. As yet another illustrative, non-exclusive example, and as discussed in more detail herein with reference to FIG. 9, long axis 216 of shim 214 and/or long axis 220 of receptacle 218 may be within a threshold angle of being parallel to, or may be parallel to, long axis 122 of archwire 120. Illustrative, non-exclusive examples of threshold angles according to the present disclosure include threshold angles of, or less than, 30 degrees, 25 degrees, 20 degrees, 15 degrees, 10 degrees, 5 degrees, 2.5 degrees, or 1 degree.

As shown in FIG. 5 at 222, when shim 214 is not inserted into shim receptacle 218, archwire 120 may fill, occlude, or otherwise be present in at least a portion of shim receptacle 218. However, and as shown in FIG. 6, when shim 214 is inserted into shim receptacle 218, shim 214 may apply a shim force, F_{S}, to the archwire, moving the archwire downward and displacing the archwire from at least a portion of shim receptacle 218. Archwire 120 will then apply an opposed archwire force, F_{A}, to shim 214 and/or shim-based prescription-altering accessory 210. This archwire force, F_{A}, which also may be referred to herein as a modifying force, represents a change in and/or alters the corrective force that are applied to the tooth, such as by archwire 120 via orthodontic bracket 105. Thus, insertion of shim 214 into shim receptacle 218 may change the prescription of orthodontic bracket 105 and/or shim-based prescription-altering accessory 210 by modifying the force applied thereto by archwire 120, thereby modifying the force applied to the tooth by orthodontic bracket 105.

Shim 214 may include any suitable structure that is sized, or configured, to be inserted and/or received within shim receptacle 218 and to generate the modifying force that alters the corrective force that is applied to the tooth by orthodontic bracket 105. As an illustrative, non-exclusive example, and as shown in FIG. 6, the shim may include a shim body 219 that separates a portion of orthodontic bracket 105 from a portion of archwire 120 and/or is located between the portion of the orthodontic bracket and the portion of the archwire, thereby generating the modifying force.

It is within the scope of the present disclosure that shim 214 may include any suitable size, length, shape, profile, cross-sectional shape, and/or cross-sectional area that may be received within shim receptacle 218 and may generate the modifying force. As an illustrative, non-exclusive example, and as discussed in more detail herein, shim 214 and/or shim body 219 thereof may include and/or be an elongate shim and/or an elongate shim body. As additional illustrative, non-exclusive examples, shim 214 and/or shim body 219 thereof may include a substantially constant cross-sectional shape, a square cross-sectional shape, a rectilinear cross-sectional shape, an L-shaped cross-sectional shape, a circular cross-sectional shape, a semi-circular cross-sectional shape, an arcuate cross-sectional shape, a trapezoidal cross-sectional shape, a triangular cross-sectional shape, a substantially constant cross-sectional area, a tapered profile, a longitudinally tapered profile, a transverse tapered profile, a stepped profile, a longitudinally stepped profile, and/or a transverse stepped profile.

It is within the scope of the present disclosure that shim 214 may be sized and/or configured to be inserted and/or received into shim receptacle 218 while archwire 120 is present, received, and/or operatively secured within archwire slot 125. As an illustrative, non-exclusive example, the shim may be inserted into the shim receptacle after, or subsequent to, the archwire being received, operatively secured, present, and/or ligated into place within the archwire slot. This may include insertion of the shim within the shim receptacle while the archwire is present and operatively secured within the archwire slot, as well as insertion of the shim within the shim receptacle while the archwire is present but not operatively secured within the archwire slot. Additionally or alternatively, it is also within the scope of the present disclosure that shim 214 may be sized and/or configured to be inserted and/or received into shim receptacle 218 prior to archwire 120 being present, received, and/or operatively secured within archwire slot 125.

When shim 214 is received and operatively secured within shim receptacle 218 and archwire 120 is received and operatively secured within archwire slot 125, a portion of shim body 219 may be compressed between and/or in mechanical contact with archwire 120 and orthodontic bracket 105. Thus, the orthodontic bracket may apply a bracket force to a portion of the shim body that contacts the orthodontic bracket, and the archwire may apply an opposed archwire force to a portion of the shim body that contacts the archwire. Additionally or alternatively, and as shown in FIGS. 5-6, the presence of shim 214 within shim receptacle 218 may alter a distance between archwire 120 and orthodontic bracket 105, alter a location of archwire 120 within archwire slot 125, alter a shape of archwire slot 125, and/or urge archwire 120 toward and/or into contact with a slot wall 128 of the archwire slot that is opposed to shim body 219.

As discussed in more detail herein with reference to FIGS. 7-16, and depending upon the particular configuration of shim 214 and/or orthodontic bracket 105, it is within the scope of the present disclosure that the presence of shim 214 and/or shim body 219 thereof within shim receptacle 218 may produce and/or generate any suitable modifying force to alter the corrective force that is applied to the tooth by the orthodontic bracket assembly (i.e., to alter the corrective force that would be applied to the tooth by the bracket assembly if the shim is not inserted into the shim receptacle). Illustrative, non-exclusive examples of modifying forces according to the present disclosure include step modifying forces, tip modifying forces, torque modifying forces, and/or rotational modifying forces.

As shown in FIGS. 5-6, archwire slot 125 may include and/or be defined by a plurality of slot walls 128 that are defined by orthodontic bracket 105 (with four such slot walls 128 being shown in the illustrative, non-exclusive examples of FIG. 5 and with it being within the scope of the disclosure that one of the walls may be, or be defined by, a gate, slot, closure, and/or ligation). When shim 214 is present within shim receptacle 218, and as shown in FIG. 6, the shim may project into and/or otherwise be present in a portion of archwire slot 125 but may not project into and/or otherwise be present in a remainder of archwire slot 125. As illustrative, non-exclusive examples, the shim may project from only one, only two, only three, or fewer than all of the slot walls 128 that define archwire slot 125. Additionally or alternatively, shim 214 and/or shim body 219 thereof may mechanically contact only one wall, only two walls, only three walls, or fewer than all of the plurality of slot walls.

Additionally or alternatively, the plurality of slot walls 128 may define a wall surface area, and shim body 219 may mechanically contact a portion of the wall surface area. Illustrative, non-exclusive examples of the portion of the wall surface area include less than 50%, less than 45%, less than 40%, less than 35%, less than 30%, less than 25%, less than 20%, less than 15%, or less than 10% of the wall surface area.

As discussed in more detail herein, shim receptacle 218 may include any suitable orientation, location, shape, and/or structure. As an illustrative, non-exclusive example, archwire slot 125 may define a fraction, a minority, a majority, and/or the entire shim receptacle. Illustrative, non-exclusive examples of the fraction of the shim receptacle according to the present disclosure that is formed or otherwise defined by the archwire slot include less than 75%, less than 50%, less than 40%, less than 30%, less than 25%, less than 20% less than 15%, less than 10%, or less than 5% of the shim receptacle, and/or at least 0.1%, at least 0.5%, at least 1%, at least 2.5%, at least 5%, at least 10%, or at least 15%, at least 25%, at least 30%, at least 50%, at least 60%, or at least 75% of the shim receptacle.

It is within the scope of the present disclosure that the shim receptacle may be coextensive with the archwire slot. However, it is also within the scope of the present disclosure that the shim receptacle may not be coextensive with the archwire slot, may include a different orientation than that of the archwire slot, may include a different cross-sectional shape than that of the archwire slot, and/or may include a different cross-sectional area than that of the archwire slot.

Archwire 120 may include any suitable structure that is configured and/or sized to be received within archwire slot 125 and/or to apply the corrective force to orthodontic bracket 105 and/or the modifying force to shim 214 when operatively secured within the archwire slot. This may include any suitable length, shape, cross-sectional shape, cross-sectional area, and/or materials of construction. As illustrative, non-exclusive examples, archwire 120 may be formed from a resilient material and/or a metallic material. As additional illustrative, non-exclusive examples, archwire 120 may include a square, rectangular, rectilinear, and/or circular cross-sectional shape. When archwire 120 includes a square or rectangular cross-sectional shape, the archwire may include a plurality of faces including at least a tooth-proximal face 160, which may be proximal to the tooth, a tooth distal face 162, which may be opposed to the tooth-proximal face, a gum-proximal face 164, which may be proximal to the gums, and a gum-distal face 166, which may be opposed to the gum-proximal face.

FIGS. 7-9 provide illustrative, non-exclusive examples of orthodontic bracket assemblies 100 that include orthodontic brackets 105 and are configured to receive shims, such as any of the shims 214 that are described, illustrated and/or incorporated herein, in shim receptacles 218. Each of FIGS. 7-9 illustrates different relative orientations of shim receptacles 218 with respect to tooth 20 and/or archwire 120. FIGS. 7-9 further illustrate that orthodontic bracket assemblies 100 may include a plurality of shim receptacles 218 and/or may be configured to receive a plurality of shims and thus generate a plurality of modifying forces that may cooperate to provide a total modifying force for a particular orthodontic bracket assembly. However, the precise number of shims and/or shim receptacles that are present and/or utilized in a particular embodiment may vary, as discussed herein, from zero to one, two, three, four, or more than four.

FIG. 7 is a schematic representation of illustrative, non-exclusive examples of a tooth 20 with an orthodontic bracket assembly 100 that includes a plurality of shim receptacles 218 according to the present disclosure. In FIG. 7, tooth 20 is viewed from the buccal, labial, or lingual direction, and the long axis of receptacles 218 (as illustrated in FIGS. 5-6) is oriented perpendicular to, or within a threshold angle of being perpendicular to, long axis 122 of archwire 120 and perpendicular to, or within a threshold angle of being perpendicular to, long axis 21 of tooth 20 (with illustrative, non-exclusive examples of threshold angles being discussed in more detail herein with reference to FIGS. 5-6). In this configuration, shims inserted into receptacles 218 may contact gum-proximal face 164 and/or gum-distal face 166 of archwire 120 and may generate tip modifying forces, torque modifying forces, and/or step modifying forces.

As an illustrative, non-exclusive example, insertion of a first shim with a substantially constant cross-sectional shape into receptacle 230 and/or insertion of a second shim with a substantially constant cross-sectional shape into receptacle 236, may generate a tipping modifying force that may tend to move crown 82 of tooth 20 in a clockwise direction. As another illustrative, non-exclusive example, insertion of a first shim with a substantially constant cross-sectional shape into receptacle 230 and insertion of a second shim with a substantially constant cross-sectional shape into receptacle 232 may generate a step modifying force that may tend to move crown 82 of tooth 20 in the gingival direction. As yet another illustrative, non-exclusive example, insertion of one or more shims with a non-constant, or tapered, cross-sectional shape into one or more receptacles 218 may twist archwire 120 along its long axis 122, generating a torque modifying force that may move crown 82 of tooth 20 in the buccolingual direction.

FIG. 8 is another schematic representation of illustrative, non-exclusive examples of a tooth 20 with an orthodontic bracket assembly 100 that includes a plurality of shim receptacles 218 according to the present disclosure. In FIG. 8, tooth 20 is viewed from the occlusal direction and the long axis of receptacles 218 (as illustrated in FIGS. 5-6) is oriented perpendicular to, or within a threshold angle of being perpendicular to, long axis 122 of archwire 120 and parallel to, or within a threshold angle of being parallel to, the long axis of tooth 20 (as illustrated in FIGS. 7 and 9 and with illustrative, non-exclusive examples of the threshold angle being discussed in more detail herein with reference to FIGS. 5-6). In this configuration, shims inserted into receptacles 218 may contact tooth-proximal face 160 and/or tooth-distal face 162 of archwire 120 and may generate torque modifying forces, rotation modifying forces, and/or step modifying forces.

As an illustrative, non-exclusive example, insertion of a first shim with a substantially constant cross-sectional shape into receptacle 230 and/or insertion of a second shim with a substantially constant cross-sectional shape into receptacle 236 may generate a rotational modifying force that may tend to rotate tooth 20 around its long axis and in a clockwise direction. As another illustrative, non-exclusive example, insertion of a first shim with a substantially constant cross-sectional shape into receptacle 230 and insertion of a second shim with a substantially constant cross-sectional shape into receptacle 232 may generate a step modifying force that may move tooth 20 in lingual direction 56. As yet another illustrative, non-exclusive example, insertion of one or more shims with a non-constant, or tapered, cross-sectional shape into receptacles 218 may twist archwire 120 along its long axis 122, generating a torque modifying force that may move crown 82 of tooth 20 in the labial/buccal 58/60 or lingual 56 direction.

FIG. 9 is another schematic representation of illustrative, non-exclusive examples of a tooth 20 with an orthodontic bracket assembly 100 that includes a shim receptacle 218 according to the present disclosure. In FIG. 9, tooth 20 is viewed from the buccolingual plane and the long axis of receptacle 218 (as illustrated in FIGS. 5-6) is oriented perpendicular to, or within a threshold angle of being perpendicular to, long axis 21 of tooth 20 and parallel to, or within a threshold angle of being parallel to, the long axis of archwire 120 (as shown in FIGS. 5-8). Illustrative, non-exclusive examples of threshold angles according to the present disclosure are discussed in more detail herein with reference to FIGS. 5-6. In this configuration, shims inserted into receptacle 218 may contact tooth-proximal face 160, tooth-distal face 162, gum-proximal face 164, and/or gum-distal face 166 of archwire 120 (as indicated in FIG. 5), and the inserted shims may generate tip modifying forces, torque modifying forces, rotation modifying forces, and/or step modifying forces to tooth 20.

As an illustrative, non-exclusive example, insertion of one or more shims with a substantially constant cross-sectional shape into receptacle 218 such that the shim contacts one of tooth-proximal face 160, tooth-distal face 162, gum-proximal face 164, or gum-distal face 166 may generate a step modifying force that may tend to move tooth 20 in a direction that is normal to the given face. As another illustrative, non-exclusive example, insertion of one or more shims with a tapered cross-sectional shape into receptacle 218 such that the shim applies a varying force to archwire 120 along tooth-proximal face 160 and/or tooth-distal face 162 may generate a rotational modifying force that may tend to rotate tooth 20 around long axis 21. As another illustrative, non-exclusive example, insertion of one or more shims with a tapered cross-sectional shape into receptacle 218 such that the shim applies a varying force to archwire 120 along gum-proximal face 164 and/or gum-distal face 166 may generate a tip modifying force that may tend to move crown 82 of the tooth in the mesial or distal directions. As yet another illustrative, non-exclusive example, insertion of one or more shims with a curved surface that tends to twist or torque archwire 120 about its long axis into receptacle 218 may generate a torque modifying force that may tend to move crown 82 of tooth 120 in the buccal/labial or lingual direction.

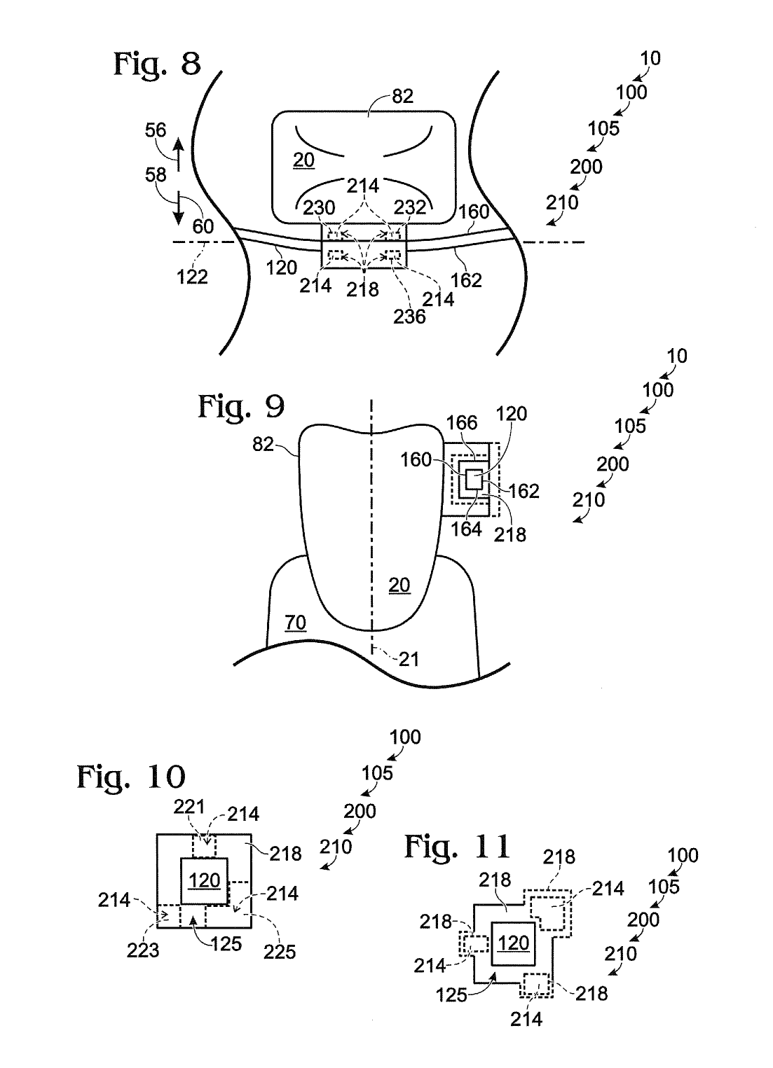

FIGS. 10-11 are less schematic representations of illustrative, non-exclusive examples of archwire slots 125 of the orthodontic bracket and bracket assemblies of FIGS. 4-9. As depicted, the archwire slots include an archwire 120, and define a portion of a shim receptacle 218 according to the present disclosure. In FIGS. 10-11, shim 214 may be inserted parallel, or at least substantially parallel, to the archwire. FIGS. 10-11 illustrate that shims 214 may be present at any suitable location within receptacle 218 such that the shims contact and/or apply a force to archwire 120. As an illustrative, non-exclusive example, shims 214 may contact a single side of archwire 120, as schematically indicated in FIG. 10 at 221. As another illustrative, non-exclusive example, shims 214 may contact a corner, or edge of archwire 120, as schematically indicated in FIG. 10 at 223. As yet another illustrative, non-exclusive example, a single shim 214 may contact multiple sides of archwire 120, as schematically indicated in FIG. 10 at 225.

Additionally or alternatively, FIGS. 10-11 also illustrate that receptacle 218 may include any suitable cross-sectional shape. As an illustrative, non-exclusive example, and as shown in FIG. 10, it is within the scope of the present disclosure that receptacle 218 may include a substantially rectilinear cross-sectional shape and/or that the cross-sectional shape of receptacle 218 may be substantially similar to a cross-sectional shape of archwire 120. However, it is also within the scope of the present disclosure that, as shown in FIG. 11, receptacle 218 may include specialized recesses, indents, cutouts, slots, and/or grooves that may be configured to accept or otherwise operatively receive shim 214.

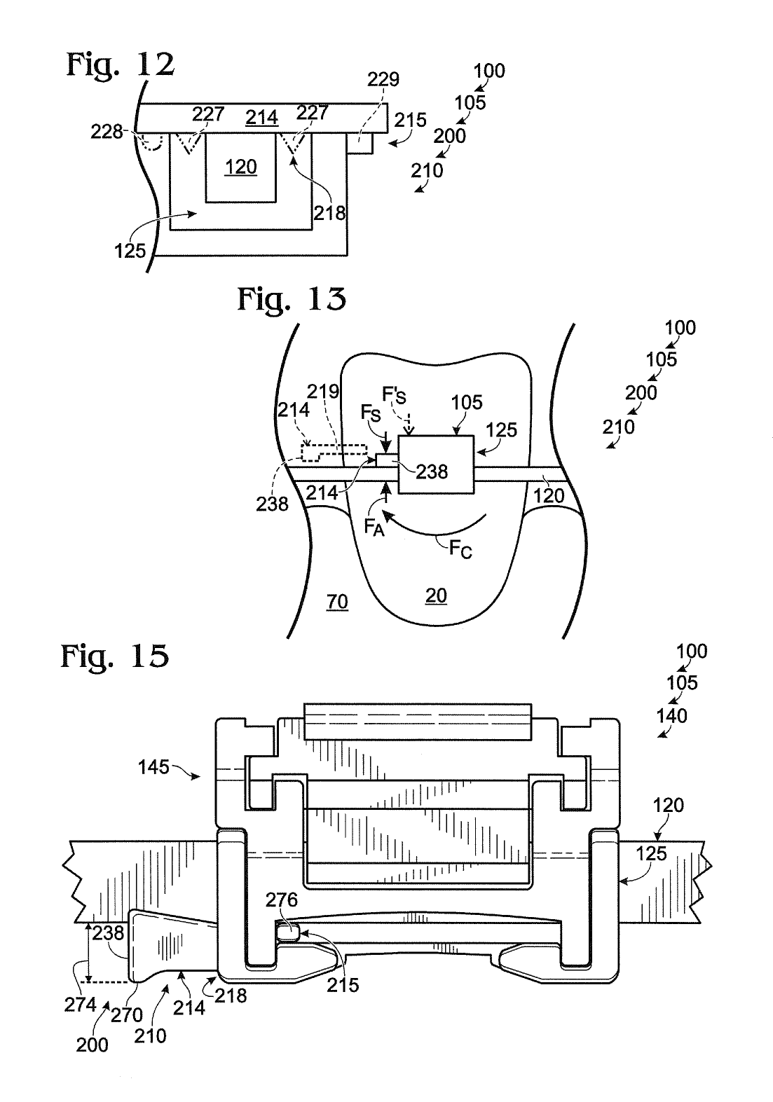

FIG. 12 is another schematic representation of illustrative, non-exclusive examples of an archwire slot 125 that includes an archwire 120. The archwire slot further defines a portion of a shim receptacle 218 and includes shim 214 according to the present disclosure, with the shim being inserted at least substantially perpendicular to the archwire (although, and as discussed in more detail herein, other relative orientations of shim 214 and/or shim receptacle 218 with respect to archwire 120 are also within the scope of the present disclosure). FIG. 12 illustrates that shim 214 may include one or more retention structures 215, such as a catch and/or a stop. Retention structures 215 may be configured to maintain a set, specific, and/or desired location of shim 214 within receptacle 218.

As an illustrative, non-exclusive example, shim 214 may include a catch 227 that is configured to maintain, or retain, shim 214 within receptacle 218. As another illustrative, non-exclusive example, receptacle 218 may include a catch 228 that is configured to maintain, or retain, shim 214 within receptacle 218. Catches 227 and 228 additionally or alternatively may be referred to as retainers, fasteners, clasps, and/or couplers, and the catches may be used and/or present independent of each other or may be configured to be used together. As yet another illustrative, non-exclusive example, shim 214 and/or receptacle 218 may include a stop 229 that is configured to limit an extent to which shim 214 may be inserted into receptacle 218. As yet another illustrative, non-exclusive example, it is within the scope of the present disclosure that shim 214 may be configured to be bent or otherwise deformed after insertion into receptacle 218 to maintain a specific, or desired, orientation of shim 214 with respect to receptacle 218 and/or to otherwise prevent unintentional removal of the shim from the receptacle.

FIG. 13 is a schematic representation of illustrative, non-exclusive examples of an orthodontic bracket assembly 100 that includes a bracket 105, and a shim 214 that includes a shim body 219 and an extension region 238 according to the present disclosure. FIG. 13 illustrates a longitudinal profile of shim 214 including both shim body 219 and extension region 238 prior to insertion of the shim into the shim receptacle in dashed lines, and FIG. 13 illustrates extension region 238 extending from the shim receptacle in solid lines. Although not required to all embodiments, the use of a shim 214 that includes extension region 238 may provide for additional flexibility in the modification of corrective forces applied to tooth 20 by shim-based prescription-altering accessory 210.

As an illustrative, non-exclusive example, and as shown schematically in FIG. 13, when extension region 238 extends past the receptacle, the force, F_{S}, that may be applied to archwire 120 by shim 214 may be larger, or at least different, in magnitude than a force, F_{S}′, that may be applied to the archwire by a shim that does not extend past the receptacle and may generate a larger, or at least different, archwire, or modifying, force, F_{A}, than might otherwise be obtained by the shim-based prescription-altering accessory. Thus, in the illustrative, non-exclusive example of FIG. 13, the tip corrective force F_{C} applied to tooth 20 by shim-based prescription-altering accessory 210 (or a corresponding orthodontic bracket 105 thereof) may be larger, or at least different, than the corrective force that might otherwise be obtained by the shim-based prescription-altering accessory if shim 214 did not extend past receptacle 218. As another illustrative, non-exclusive example, and since extension region 238 may contact archwire 120 outside archwire slot 125, shim 214 may deflect the archwire more than may be possible without extension region 238, thereby producing a larger modifying force than may be possible when using a shim that does not include extension region 238.

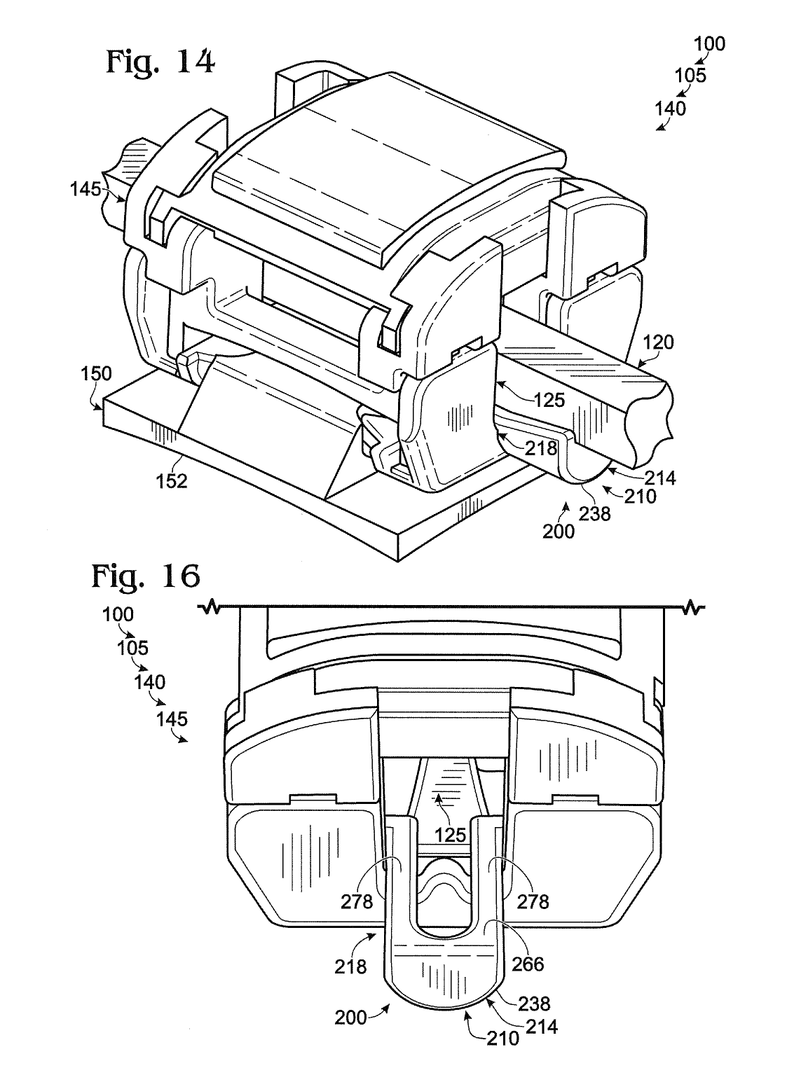

FIGS. 14-16 provide less schematic but still illustrative, non-exclusive examples of another orthodontic bracket assembly 100 that includes a bracket 105 with a shim receptacle 218 and a shim 214 that includes an extension region 238 according to the present disclosure. FIGS. 14-16 illustrate a self-ligating orthodontic bracket 140 that may be utilized with prescription-altering accessories 200 according to the present disclosure, although the depicted shim 214 and shim receptacle 218 may be used with other brackets 105, including brackets that are not self-ligating brackets.

Similar to shim-based prescription-altering accessories 210 of FIGS. 5-13, shim-based prescription-altering accessories 210 of FIGS. 14-16 include the use of a shim 214 to change and/or modify the corrective forces that are applied to a tooth by orthodontic assembly 100 and/or orthodontic bracket 105 when an archwire is operatively secured within the corresponding archwire slot. As shown in FIG. 14, shim 214 is configured to be utilized in conjunction with an orthodontic bracket 140 with a bracket body 150 having a base 152. Base 150 may be operatively attached to a tooth, and a gate, or closure, 145 cooperates with the base to define archwire slot 125 and to selectively retain archwire 120 therein. However, it is within the scope of the present disclosure that shim 214 may be utilized with any suitable orthodontic bracket, including any suitable ligating and/or self-ligating orthodontic bracket. As an illustrative, non-exclusive example, shim 214 may be utilized with any suitable dedicated and/or specialized orthodontic bracket 105 that is configured for use with the shim. As another illustrative, non-exclusive example, shim 214 may, additionally or alternatively, be utilized with any suitable existing, conventional, and/or standard orthodontic bracket 105 that is not specifically configured for use with the shim. This may include any of the orthodontic brackets 105 that are discussed in more detail and/or incorporated by reference herein.

A portion of shim 214 of FIGS. 14-16 may be inserted into archwire slot 125, and (as indicated in FIGS. 14-15) archwire 120 may contact, apply a force to, and/or be deflected by archwire-contacting surface 266 of the shim (shown in FIG. 16), thereby modifying the corrective forces that are applied to the tooth through the use of shim 214. As illustrated in FIG. 15, shim 214 may include tooth-contacting surface 270 that may contact and/or apply a force to the tooth to which base 152 is attached. The use of a shim 214 that includes tooth-contacting surface 270, as well as archwire-contacting surface 266, may increase, or at least change, a magnitude of the corrective force modification that may be obtained through the use of shim 214.

As an illustrative, non-exclusive example, when tooth-contacting surface 270 of shim 214 is in contact with the tooth, and archwire-contacting surface 266 is in contact with the archwire, the deflection of archwire 120 that may be obtained through the use of shim 214 may be governed by a thickness 274 (as indicated in FIG. 15) of shim 214 and may not be limited by a cross-sectional shape of archwire slot 125 relative to a cross-sectional shape of archwire 120. Additionally or alternatively, the use of a shim 214 that includes both tooth-contacting surface 270 and archwire contacting surface 266 may provide for a decrease in the extent to which shim 214 is inserted into archwire slot 125 to produce a given, or desired, magnitude of the modifying force that alters the corrective force applied to the tooth by the orthodontic assembly. Similarly, the use of a shim 214 that includes both tooth-contacting surface 270 and archwire-contacting surface 266 may provide for the use of a softer, more compliant, less rigid, and/or less resilient material in the construction of shim 214, since the modifying force applied to the tooth through the use of shim 214 is caused by a compressive force placed on shim 214 by archwire 120 and the tooth, as opposed to a tensile or torque force on shim 214.

As discussed in more detail herein, shims 214 also may include any suitable retention structure 215, such as a catch and/or stop, that is configured to retain the shim within orthodontic bracket 105 and/or limit insertion of the shim into the orthodontic bracket. In the illustrative, non-exclusive example of FIGS. 14-16, retention structure 215 (as best seen in FIG. 15) includes a pair of protruding stops 276, retainers 276, or catches 276 that are operatively attached to resilient arms 278 (as best seen in FIG. 16). Resilient arms 278 may be deflected to facilitate insertion of shim 214 into orthodontic bracket 105 and may be biased to retain catches 276 in contact with orthodontic bracket 105 and thus retain shim 214 within the orthodontic bracket when not in the deflected state. Although two catches are shown in the illustrative, non-exclusive example of FIG. 15, it is within the scope of the present disclosure that a single catch or more than two catches may be utilized. It is also within the scope of the present disclosure that other suitable positioning and/or retaining structures may be utilized, such as those that are discussed in more detail herein.

FIGS. 17-20 provide illustrative, non-exclusive examples of orthodontic bracket assemblies 100 and/or components thereof that include an orthodontic bracket 105 and a prescription-altering accessory 200 in the form of a prescription-altering cap 250, which also may be referred to herein as a cap 250. Prescription-altering cap 250 may attach to any suitable portion of orthodontic assembly 200, including bracket 105, bracket body 150, and/or archwire 120 and may generate a modifying force that alters the corrective force that is applied to a tooth 20 by the orthodontic assembly.

FIG. 17 is a schematic representation of illustrative, non-exclusive examples of a tooth 20 including an orthodontic bracket assembly 100 that includes an orthodontic bracket 105 with a bracket body 150 and a prescription-altering cap 250 according to the present disclosure as viewed from the buccolingual plane. Orthodontic bracket 105 defines archwire slot 125, which is configured to receive archwire 120. As discussed in more detail herein, orthodontic bracket 105 may be a ligating orthodontic bracket 110 that may utilize a ligature 132 to operatively secure the archwire within the archwire slot. Alternatively, the orthodontic bracket may be self-ligating orthodontic bracket 140 that may utilize a gate 145 to operatively secure the archwire within the archwire slot.

Cap 250 may include a cap retention structure 252 that is configured to operatively attach cap 250 to orthodontic bracket assembly 100, such as to orthodontic bracket 105, bracket body 150, ligature 132, gate 145, and/or archwire 120 thereof, in any suitable manner. As an illustrative, non-exclusive example, cap 250 and/or cap retention structure 252 thereof may be affixed, or operatively attached, to archwire 120, as indicated schematically at 240. As another illustrative, non-exclusive example, cap 250 and/or cap retention structure 252 thereof may be operatively attached to bracket body 150 or other portion of a bracket 105 at any suitable location, as indicated schematically at 244. As yet another illustrative, non-exclusive example, at least a portion of cap 250 and/or cap retention structure 252 thereof may surround and/or otherwise contain and/or extend around a portion of bracket body 150, as indicated schematically at 248.

FIG. 18 is another schematic representation of illustrative, non-exclusive examples of a tooth 20 including an orthodontic bracket assembly 100 that includes an orthodontic bracket and a prescription-altering cap 250 according to the present disclosure, as viewed from the buccal, labial, or lingual direction. As shown in FIG. 18, prescription-altering cap 250 may include one or more protrusions 254 (and in some embodiments may include two or more protrusions 254) that extend past a cap body 262 of prescription-altering cap 250 and are configured to apply a force to archwire 120, that deflects the archwire and thereby generates a modifying force that alters the corrective force that is provided to tooth 20 by orthodontic assembly 100. In the illustrative, non-exclusive example of FIG. 18, protrusions 254 may contact gum-proximal surface 164 and gum-distal surface 166 of archwire 120, thereby generating a tipping modifying force, F_{M}, as shown. The tipping corrective force may move crown 82 of tooth 20 in the mesial or distal direction. However, other configurations are also within the scope of the present disclosure. Protrusions 254 may additionally or alternatively be referred to herein as projections, arms, extensions, archwire-engaging portions, and/or tabs.

FIG. 19 is a side view of illustrative, non-exclusive examples of a prescription-altering cap 250 according to the present disclosure. In FIG. 19, prescription-altering cap 250 includes retention structure 252 that may operatively attach the prescription-altering cap to the orthodontic appliance. In addition, the prescription-altering cap also includes protrusions 254 that are configured to apply a force to the archwire and thus modify the corrective forces applied to the tooth by the orthodontic bracket and cap body 262. FIG. 20 provides a back side view of the prescription-altering cap of FIG. 19.

While FIGS. 17-20 illustrate a prescription-altering cap 250 that may modify and/or alter the tipping corrective force that is applied to tooth 20 by orthodontic bracket assembly 100, it is within the scope of the present disclosure that prescription-altering cap 250 may alter any suitable tip corrective force, torque corrective force, rotational corrective force, and/or step corrective force that may be applied to tooth 20 by orthodontic bracket assembly 100. This may include prescription-altering caps 250 that are configured to apply any suitable force to archwire 120, including the forces discussed herein with respect to the shim-based prescription-altering accessory of FIGS. 5-16. Thus, it is within the scope of the present disclosure that prescription-altering cap 250 may be considered to exert any of the forces on archwire 120 that may be exerted on the archwire by shims 214 of shim-based prescription-altering accessory 210 through the incorporation of the structure of shim 214 into the structure of prescription-altering cap 250.

Similarly, and as discussed herein with reference to shim-based prescription-altering accessory 210, it is within the scope of the present disclosure that protrusions 254 may not extend past body 262 of the prescription-altering cap. However, and as discussed in more detail herein, when protrusions extend past body 262 of prescription-altering cap 250, the alteration in the corrective forces that may be obtained by the prescription-altering cap may be larger, or at least different from, the alteration in the corrective forces that may be obtained when the protrusions do not extend past body 262.

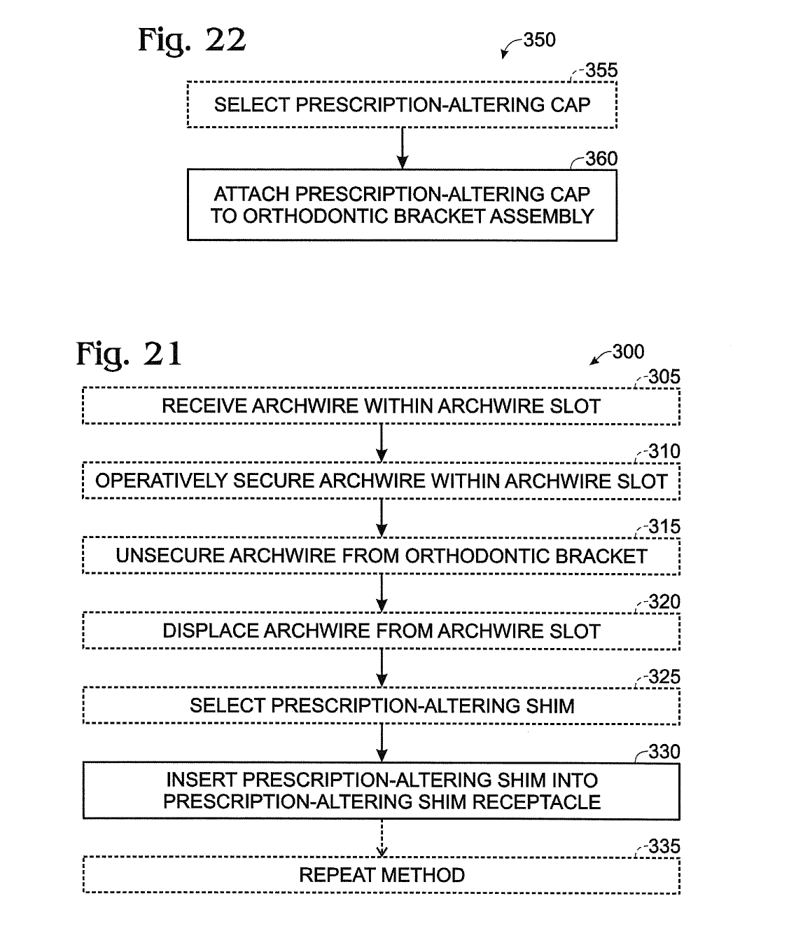

FIG. 21 provides illustrative, non-exclusive examples of methods 300 according to the present disclosure of altering a corrective force that is applied to a tooth by an orthodontic bracket assembly using a shim. Methods 300 include inserting a shim into a shim receptacle of the orthodontic bracket at 330. The methods optionally may include receiving an archwire within an archwire slot of the orthodontic bracket at 305, operatively securing the archwire within the archwire slot at 310, unsecuring the archwire from the orthodontic bracket at 315, displacing the archwire from the archwire slot at 320, and/or selecting the shim from a plurality of shims at 325. The methods further may include repeating the method at 335.

Receiving the archwire within the archwire slot at 305 may include locating, placing, and/or otherwise moving the archwire into the archwire slot of the orthodontic bracket such that the archwire may be operatively secured therein and/or such that the archwire may apply an archwire force, or a corrective force, to the orthodontic bracket. Operatively securing the archwire within the archwire slot at 310 may include the use of any suitable structure to attach, ligate, and/or otherwise retain the archwire within the archwire slot. As an illustrative, non-exclusive example, the operatively securing may include the use of a ligating structure, or ligature, to retain the archwire within the archwire slot. As another illustrative, non-exclusive example, the operatively securing may include closing and/or otherwise securing a gate of a self-ligating bracket to retain the archwire therein. It is within the scope of the present disclosure that the archwire may be operatively secured within the archwire slot prior to the inserting at 330. It is also within the scope of the present disclosure that the archwire may be operatively secured within the archwire slot subsequent to the inserting at 330.

When the orthodontic bracket includes a ligating orthodontic bracket, unsecuring the archwire from the orthodontic bracket at 315 may include removing a ligating structure and/or ligature from the orthodontic bracket such that the archwire may move relative to the orthodontic bracket. Additionally or alternatively, and when the orthodontic bracket includes a self-ligating orthodontic bracket, unsecuring the archwire from the orthodontic bracket at 315 may include opening a gate of the self-ligating orthodontic bracket such that the archwire may move relative to the orthodontic bracket.

Displacing the archwire from the archwire slot at 320 may include removing the archwire from the archwire slot and/or from the orthodontic assembly. Additionally or alternatively, the displacing may include displacing the archwire relative to the orthodontic bracket, such as to provide for receipt of the shim within the shim receptacle.

Selecting the shim at 325 may include selecting any suitable shim for insertion into any suitable shim receptacle. As an illustrative, non-exclusive example, the selecting may include selecting a shim that may generate a desired modifying force when inserted into the shim receptacle from a plurality of shims that may be designed, sized, and/or configured to provide a plurality of different modifying forces, including the illustrative, non-exclusive examples of modifying forces that are discussed in more detail herein. It is within the scope of the present disclosure that the selecting may be based, at least in part, on a difference between a current corrective force that is being applied to the tooth by the orthodontic bracket and a target corrective force that is desired to be applied to the tooth by the orthodontic bracket.

Inserting the shim into the shim receptacle may include pressing, sliding, positioning, and/or otherwise urging the shim into the shim receptacle. It is within the scope of the present disclosure that the inserting may be performed after the archwire has been received within the archwire slot and/or operatively secured within the archwire slot. Additionally or alternatively, it is also within the scope of the present disclosure that the inserting may be performed prior to the archwire being received within the archwire slot, prior to the archwire being operatively secured within the archwire slot, subsequent to the archwire being unsecured from the orthodontic bracket and/or the archwire slot, and/or subsequent to the archwire being displaced from the archwire slot. When the archwire is received and/or present within the archwire slot during the inserting, the inserting may include displacing and/or deflecting the archwire within the archwire slot and/or compressing the shim between the archwire and the orthodontic bracket.

Repeating the method at 335 may include repeating any suitable portion of methods 300, such as of steps 305-330, to select and/or insert a second, or a subsequent, shim into any suitable shim receptacle. This may include inserting to generate a second, or subsequent, modifying force that cooperates with a first modifying force that is generated by the inserting at 330 to produce a total modifying force for the orthodontic bracket assembly and/or a selected orthodontic bracket thereof. It is within the scope of the present disclosure that the repeating may include inserting the second, or subsequent, shim into a second, or subsequent, shim receptacle that is different from the shim receptacle that was utilized during the inserting at 330. Additionally or alternatively, it is also within the scope of the present disclosure that the repeating may include inserting the second, or subsequent, shim into the same shim receptacle that was utilized during the inserting at 330.

FIG. 22 provides illustrative, non-exclusive examples of methods 350 according to the present disclosure of altering a corrective force that is applied to a tooth by an orthodontic bracket assembly using a prescription-altering cap. Methods 300 may include selecting a prescription-altering cap at 355 and include attaching the prescription-altering cap to an orthodontic bracket, or bracket assembly, at 360.

Selecting the prescription-altering cap at 355 may be substantially similar to selecting the shim at 325 of method 300 and may include selecting the prescription-altering cap based upon any suitable criteria. As an illustrative, non-exclusive example, the selecting may include selecting the prescription-altering cap from a plurality of prescription-altering caps that define a plurality of different modifying forces when attached to the orthodontic bracket. As another illustrative, non-exclusive example, the selecting may include selecting based, at least in part, on a difference between a current corrective force that is being applied by a given orthodontic bracket and a target corrective force that is desired to be applied by the given orthodontic bracket.

Attaching the prescription-altering cap to the orthodontic bracket assembly at 360 may include attaching the prescription-altering cap such that the prescription-altering cap engages the archwire and generates a desired modifying force. This may include attaching the prescription-altering cap to any suitable structure, illustrative, non-exclusive examples of which include the orthodontic bracket, a bracket base of the orthodontic bracket, a bracket body of the orthodontic bracket, a ligating structure of the orthodontic bracket, a ligating structure that is attached to the orthodontic bracket, and/or the archwire.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, patent applications, or other references are incorporated by reference herein and define a term in a manner or are otherwise inconsistent with either the non-incorporated portion of the present disclosure or with any of the other incorporated references, the non-incorporated portion of the present disclosure shall control, and the term or incorporated disclosure therein shall only control with respect to the reference in which the term is defined and/or the incorporated disclosure was originally present.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

Illustrative, non-exclusive examples of systems and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

A1. A prescription-altering shim configured to alter a corrective force that is applied to a tooth by an orthodontic bracket, wherein the orthodontic bracket defines an archwire slot that is sized to receive an archwire, wherein the orthodontic bracket further includes a prescription-altering shim receptacle that is sized to receive the prescription-altering shim, and further wherein the orthodontic bracket is configured to be attached to the tooth and to apply the corrective force to the tooth when the archwire is received and operatively secured within the archwire slot, the prescription-altering shim comprising:

a shim body, wherein the shim body is sized to be received within the prescription-altering shim receptacle and to separate a portion of the orthodontic bracket from a portion of the archwire, and further wherein the shim body generates a modifying force that alters the corrective force that is applied to the tooth by the orthodontic bracket when the shim body is received and operatively secured within the prescription-altering shim receptacle.

A2. The prescription-altering shim of paragraph A1, wherein the shim body is sized to be inserted into the prescription-altering shim receptacle while the archwire is present, received, and/or operatively secured within the archwire slot.

A3. The prescription-altering shim of any of paragraphs A1-A2, wherein the shim body is sized to be inserted into the prescription-altering shim receptacle subsequent to the archwire being received, operatively secured, present, and/or ligated within the archwire slot.

A4. The prescription-altering shim of any of paragraphs A1-A3, wherein at least a portion of the shim body is compressed between the archwire and the orthodontic bracket when the prescription-altering shim is present within the prescription-altering shim receptacle.

A5. The prescription-altering shim of any of paragraphs A1-A4, wherein the shim body is sized to alter a distance between the orthodontic bracket and the archwire when the prescription-altering shim is present within the prescription-altering shim receptacle.

A6. The prescription-altering shim of any of paragraphs A1-A5, wherein, when the shim body is received and operatively secured within the prescription-altering shim receptacle, an orthodontic bracket-contacting portion of the shim body is in mechanical contact with the orthodontic bracket and an archwire-contacting portion of the shim body is in mechanical contact with the archwire.

A7. The prescription-altering shim of paragraph A6, wherein the orthodontic bracket applies a bracket force to the orthodontic bracket-contacting portion of the shim body, and further wherein the archwire applies an opposed archwire force to the archwire-contacting portion of the shim body.

A8. The prescription-altering shim of any of paragraphs A1-A7, wherein the shim body modifies a shape of at least a portion of the archwire slot when the shim body is received and operatively secured within the prescription-altering shim receptacle.

A9. The prescription-altering shim of any of paragraphs A1-A8, wherein the shim body changes a location of the archwire within the archwire slot when the shim body is received and operatively secured within the prescription-altering shim receptacle.

A10. The prescription-altering shim of any of paragraphs A1-A9, wherein the shim body generates at least one of a step modifying force, a tip modifying force, a torque modifying force, and a rotational modifying force when the shim body is received and operatively secured within the prescription-altering shim receptacle and the archwire is received and operatively secured within the archwire slot.

A11. The prescription-altering shim of any of paragraphs A1-A10, wherein the shim body projects into a portion of the archwire slot, optionally wherein the archwire slot is defined by a plurality of slot walls of the orthodontic bracket and the shim body projects from only one wall of the plurality of slot walls, only two walls of the plurality of slot walls, only three walls of the plurality of slot walls, or fewer than all of the plurality of slot walls of the archwire slot.

A12. The prescription-altering shim of any of paragraphs A1-A11, wherein the archwire slot is defined by a/the plurality of slot walls of the orthodontic bracket.

A13. The prescription-altering shim of paragraph A12, wherein the shim body mechanically contacts only one wall of the plurality of slot walls, only two adjacent walls of the plurality of slot walls, only three walls of the plurality of slot walls, or fewer than all of the plurality of slot walls.

A14. The prescription-altering shim of any of paragraphs A12-A13, wherein the plurality of slot walls define a wall surface area, and further wherein the shim body mechanically contacts less than 50%, less than 45%, less than 40%, less than 35%, less than 30%, less than 25%, less than 20%, less than 15%, or less than 10% of the wall surface area.

A15. The prescription-altering shim of any of paragraphs A1-A14, wherein, when the shim body is received and operatively secured within the prescription-altering shim receptacle, the shim body urges the archwire toward, against, and/or into contact with a slot wall of the archwire slot that is opposed to the shim body.

A16. The prescription-altering shim of any of paragraphs A1-A15, wherein the shim body is an elongate shim body that defines a shim longitudinal direction when the shim body is received and operatively secured within the prescription-altering shim receptacle, optionally wherein the tooth defines a tooth longitudinal direction, optionally wherein the archwire defines an archwire longitudinal direction that is defined by a portion of the archwire that is received within the archwire slot, optionally wherein the archwire includes a tooth-proximal face and an opposed tooth-distal face, and further optionally wherein the archwire includes a gum-proximal face and an opposed gum-distal face.

A17. The prescription-altering shim of paragraph A16, wherein a/the shim longitudinal direction is within a threshold angle of being parallel to, and optionally is parallel to, a/the archwire longitudinal direction.

A18. The prescription-altering shim of paragraph A17, wherein the shim body includes a substantially constant, and optionally a constant, cross-sectional shape.

A19. The prescription-altering shim of paragraph A18, wherein the prescription-altering shim generates a step modifying force when the shim body is received and operatively secured within the prescription-altering shim receptacle and the archwire is received and operatively secured within the archwire slot.

A20. The prescription-altering shim of paragraph A17, wherein the shim body includes a tapered cross-sectional shape.

A21. The prescription-altering shim of paragraph A20, wherein the prescription-altering shim generates a rotational modifying force when the archwire is received and operatively secured within the archwire slot, when the shim body is received and operatively secured within the prescription-altering shim receptacle, and when the shim body is in mechanical contact with at least one of a/the tooth-proximal face and a/the tooth-distal face.

A22. The prescription-altering shim of any of paragraphs A20-A21, wherein the prescription-altering shim generates a tip modifying force when the archwire is received and operatively secured within the archwire slot, when the shim body is received and operatively secured within the prescription-altering shim receptacle, and when the shim body is in mechanical contact with at least one of a/the gum-proximal face and a/the gum-distal face.

A23. The prescription-altering shim of paragraph A17, wherein the shim body includes a curved surface that contacts and twists the archwire along a/the archwire longitudinal direction.

A24. The prescription-altering shim of paragraph A23, wherein the prescription-altering shim generates a torque modifying force when the archwire is received and operatively secured within the archwire slot, when the shim body is received and operatively secured within the prescription-altering shim receptacle, and when the curved surface is in contact with the archwire.

A25. The prescription-altering shim of paragraph A16, wherein the shim longitudinal direction is within a threshold angle of being perpendicular to, and optionally is perpendicular to, a/the archwire longitudinal direction, wherein the shim longitudinal direction is within the threshold angle of being perpendicular to, and optionally is perpendicular to, a/the tooth longitudinal direction, and optionally wherein the shim body contacts at least one of a/the gum-proximal face of the archwire and a/the gum-distal face of the archwire when the shim body is received and operatively secured within the prescription-altering shim receptacle.

A26. The prescription-altering shim of paragraph A25, wherein the shim body includes a substantially constant, and optionally a constant, cross-sectional shape.

A27. The prescription-altering shim of paragraph A26, wherein the prescription-altering shim generates at least one of a step modifying force and a tip modifying force when the archwire is received and operatively secured within the archwire slot and when the shim body is received and operatively secured within the prescription-altering shim receptacle.

A28. The prescription-altering shim of paragraph A25, wherein the shim body includes a tapered cross-sectional shape.

A29. The prescription-altering shim of paragraph A28, wherein the prescription-altering shim generates a torque modifying force when the archwire is received and operatively secured within the archwire slot and when the shim body is received and operatively secured within the prescription-altering shim receptacle.

A30. The prescription-altering shim of paragraph A16, wherein the shim longitudinal direction is within a threshold angle of being perpendicular to, and optionally is perpendicular to, a/the archwire longitudinal direction, wherein the shim longitudinal direction is within the threshold angle of being parallel to, and optionally is parallel to, a/the tooth longitudinal direction, and optionally wherein the shim body contacts at least one of the tooth-proximal face and the tooth-distal face when the shim body is received and operatively secured within the prescription-altering shim receptacle.

A31. The prescription-altering shim of paragraph A30, wherein the shim body includes a substantially constant, and optionally a constant, cross-sectional shape.

A32. The prescription-altering shim of paragraph A31, wherein the prescription-altering shim generates at least one of a step modifying force and a rotational modifying force when the archwire is received and operatively secured within the archwire slot and when the shim body is received and operatively secured within the prescription-altering shim receptacle.

A33. The prescription-altering shim of paragraph A30, wherein the shim body includes a tapered cross-sectional shape.

A34. The prescription-altering shim of paragraph A33, wherein the prescription-altering shim generates a torque modifying force when the archwire is received and operatively secured within the archwire slot and the prescription-altering shim is received and operatively secured within the prescription-altering shim receptacle.

A35. The prescription-altering shim of any of paragraphs A17-A34, wherein the threshold angle is less than 30 degrees, less than 25 degrees, less than 20 degrees, less than 15 degrees, less than 10 degrees, less than 5 degrees, less than 2.5 degrees, or less than 1 degree.

A36. The prescription-altering shim of any of paragraphs A1-A35, wherein the shim body includes an elongate shim body.

A37. The prescription-altering shim of any of paragraphs A1-A36, wherein the shim body includes a substantially constant transverse cross-sectional shape.

A38. The prescription-altering shim of any of paragraphs A1-A37, wherein the shim body includes a tapered profile, optionally wherein the tapered profile includes a longitudinally tapered profile, and further optionally wherein the tapered profile includes a transverse tapered profile.

A39. The prescription-altering shim of any of paragraphs A1-A38, wherein the shim body includes at least one of a square, rectilinear, L-shaped, circular, semi-circular, arcuate, trapezoidal, and triangular transverse cross-sectional shape.

A40. The prescription-altering shim of any of paragraphs A1-A39, wherein the shim body includes a stepped profile, optionally wherein the stepped profile includes a longitudinally stepped profile, and further optionally wherein the stepped profile includes a transverse stepped profile.

A41. The prescription-altering shim of any of paragraphs A1-A40, wherein the prescription-altering shim includes an extension region that is not contained within the prescription-altering shim receptacle when the shim body is received and operatively secured within the prescription-altering shim receptacle, and optionally wherein the extension region generates a portion of the modifying force.

A42. The prescription-altering shim of paragraph A41, wherein the extension region extends to contact a portion of the archwire that is not received within the archwire slot and to deflect the portion of the archwire that is not received within the archwire slot to generate the portion of the modifying force.

A43. The prescription-altering shim of any of paragraphs A41-A42, wherein the extension region includes a tooth-contacting portion that contacts the tooth when the shim body is received and operatively secured within the prescription-altering shim receptacle.

A44. The prescription-altering shim of paragraph A43, wherein the tooth-contacting portion applies an extension region corrective force to the tooth to generate the portion of the modifying force when the shim body is received and operatively secured within the prescription-altering shim receptacle and the archwire is received and operatively secured within the archwire slot.

A45. The prescription-altering shim of any of paragraphs A41-A44, wherein at least a portion of the extension region is compressed between the archwire and the tooth when the archwire is received and operatively secured within the archwire slot and the portion of the prescription-altering shim is received and operatively secured within the prescription-altering shim receptacle.

A46. The prescription-altering shim of any of paragraphs A41-A45, wherein the orthodontic bracket is a self-ligating orthodontic bracket that includes a base that attaches to the tooth and defines a base portion of the archwire slot, wherein the orthodontic bracket further includes a closure that defines a closure portion of the archwire slot and that operatively secures the archwire within the archwire slot.

A47. The prescription-altering shim of any of paragraphs A1-A46, wherein the prescription-altering shim, and optionally the shim body, further includes a locating structure, optionally wherein the locating structure at least one of retains the prescription-altering shim within the prescription-altering shim receptacle and limits insertion of the prescription-altering shim into the prescription-altering shim receptacle, and further optionally wherein the locating structure includes at least one of a catch and a stop.

B1. An orthodontic bracket, comprising:

a bracket body, wherein the bracket body defines an archwire slot that is sized to receive an archwire, wherein the bracket body further defines a bracket base that attaches to a tooth and applies a corrective force to the tooth when the archwire is received and operatively secured within the archwire slot, and further wherein the bracket body includes a prescription-altering shim receptacle that is sized to receive a prescription-altering shim.

B2. The orthodontic bracket of paragraph B1, wherein the archwire slot defines an archwire slot longitudinal direction that is parallel to an archwire longitudinal direction, wherein the archwire longitudinal direction is defined by a portion of the archwire that is received within the archwire slot, wherein the prescription-altering shim receptacle defines a receptacle longitudinal direction, and further wherein the archwire longitudinal direction is at least one of parallel to and perpendicular to the receptacle longitudinal direction.

B3. The orthodontic bracket of any of paragraphs B1-B2, wherein the archwire slot defines at least a majority, and optionally all, of the prescription-altering shim receptacle.

B4. The orthodontic bracket of any of paragraphs B1-B3, wherein the prescription-altering shim receptacle is not coextensive with the archwire slot.

B5. The orthodontic bracket of any of paragraphs B1-B4, wherein the prescription-altering shim receptacle includes a receptacle cross-section, wherein the archwire slot includes a slot cross-section, and further wherein the receptacle cross-section is different from the slot cross-section.

B6. The orthodontic bracket of any of paragraphs B1-B5, wherein a portion of the prescription-altering shim projects into a portion of the archwire slot, optionally wherein the archwire slot is defined by a plurality of slot walls of the orthodontic bracket and the portion of the prescription-altering shim projects from only one wall of the plurality of slot walls, only two walls of the plurality of slot walls, only three walls of the plurality of slot walls, or less than all of the plurality of slot walls of the archwire slot, and further optionally wherein the portion of the prescription-altering shim includes a shim body of the prescription-altering shim or a portion of the shim body of the prescription-altering shim.

B7. The orthodontic bracket of any of paragraphs B1-B6, wherein the archwire slot is defined by a/the plurality of slot walls of the orthodontic bracket.

B8. The orthodontic bracket of paragraph B7, wherein a portion of the prescription-altering shim mechanically contacts only one wall of the plurality of slot walls, only two adjacent walls of the plurality of slot walls, only three walls of the plurality of slot walls, or less than all of the plurality of slot walls.

B9. The orthodontic bracket of any of paragraphs B7-B8, wherein the plurality of slot walls define a wall surface area, and further wherein the prescription-altering shim mechanically contacts less than 50%, less than 45%, less than 40%, less than 35%, less than 30%, less than 25%, less than 20%, less than 15%, or less than 10% of a surface area of the wall surface area.

B10. The orthodontic bracket of any of paragraphs B1-B9, wherein, when the shim body is received and operatively secured within the prescription-altering shim receptacle, the prescription-altering shim urges the archwire toward, against, and/or into contact with a slot wall of the archwire slot that is opposed to the shim body.

B11. The orthodontic bracket of any of paragraphs B1-B10, wherein the archwire slot defines a fraction of the prescription-altering shim receptacle, optionally wherein the fraction of the prescription-altering shim receptacle includes less than 50%, less than 40%, less than 30%, less than 25%, less than 20% less than 15%, less than 10%, or less than 5% of the prescription-altering shim receptacle, and further optionally wherein the fraction of the prescription-altering shim receptacle includes at least 0.1%, at least 0.5%, at least 1%, at least 2.5%, at least 5%, at least 10%, or at least 15% of the prescription-altering shim receptacle.

B12. The orthodontic bracket of any of paragraphs B1-B11, wherein the orthodontic bracket includes a plurality of prescription-altering shim receptacles, and optionally wherein the plurality of prescription-altering shim receptacles includes a plurality of spaced-apart prescription altering shim receptacles and/or a plurality of discrete prescription-altering shim receptacles.

B13. The orthodontic bracket of any of paragraphs B1-B12, wherein the bracket body includes a monolithic bracket body, and optionally wherein the orthodontic bracket includes a monolithic orthodontic bracket.

B14. The orthodontic bracket of any of paragraphs B1-B13, wherein the orthodontic bracket is formed from a plurality of components, wherein the plurality of components is operatively attached to one another to form the orthodontic bracket.

B15. The orthodontic bracket of any of paragraphs B1-B14, wherein the orthodontic bracket further includes a ligating structure that retains the archwire within the archwire slot.

C1. An orthodontic bracket assembly, comprising:

an orthodontic bracket; and

a prescription-altering shim including a shim body.

C2. The orthodontic bracket assembly of paragraph C1, wherein the orthodontic bracket includes the orthodontic bracket of any of paragraphs B1-B8.

C3. The orthodontic bracket assembly of any of paragraphs C1-C2, wherein the prescription-altering shim includes the prescription-altering shim of any of paragraphs A1-A38.

C4. The orthodontic bracket assembly of any of paragraphs C1-C3, wherein the shim body is received and operatively secured within a/the prescription-altering shim receptacle and separates a/the portion of the orthodontic bracket from a/the portion of the archwire.

C5. The orthodontic bracket assembly of any of paragraphs C1-C4, wherein an/the archwire is received within a/the archwire slot.

C6. The orthodontic bracket assembly of any of paragraphs C1-C5, wherein the orthodontic bracket assembly further includes an/the archwire.

C7. The orthodontic bracket assembly of any of paragraphs C1-C6, wherein the orthodontic bracket assembly includes a plurality of orthodontic brackets, wherein each of the plurality of orthodontic brackets defines a respective portion of a respective archwire slot, optionally wherein an/the archwire is received in each of the respective portions of the respective archwire slots, and further optionally wherein each of the plurality of orthodontic brackets defines a respective prescription-altering shim receptacle that is sized to receive a respective prescription-altering shim.

C8. The orthodontic bracket assembly of any of paragraphs C1-C7, wherein the orthodontic bracket assembly further includes a ligating structure that retains the archwire within the archwire slot.

C9. The orthodontic bracket assembly of paragraph C8, wherein the ligating structure forms a portion of the orthodontic bracket, and optionally wherein the orthodontic bracket is a self-ligating orthodontic bracket.

C10. The orthodontic bracket assembly of paragraph C8, wherein the ligating structure is operatively attached to the orthodontic bracket, and optionally wherein the orthodontic bracket is at least one of a self-ligating orthodontic bracket and a non-self-ligating orthodontic bracket.

C11. The orthodontic bracket assembly of any of paragraphs C1-C10, wherein the orthodontic bracket defines a plurality of prescription-altering shim receptacles including at least a first prescription-altering shim receptacle and a second prescription-altering shim receptacle.

C12. The orthodontic bracket assembly of paragraph C11, wherein the prescription-altering shim is a first prescription-altering shim that is sized to be received in, and optionally is received in, the first prescription-altering shim receptacle, and further wherein the orthodontic bracket assembly includes a second prescription-altering shim that is sized to be received in, and optionally is received in, the second prescription-altering shim receptacle.

C13. The orthodontic bracket assembly of paragraph C12, wherein the first prescription-altering shim generates a first modifying force, wherein the second prescription-altering shim generates a second modifying force, and further wherein a total modifying force includes the first modifying force and the second modifying force.

D1. A kit of components configured to be utilized to apply a corrective force to a tooth, the kit comprising:

a plurality of prescription-altering shims, wherein each of the plurality of prescription-altering shims is sized to be received within a prescription-altering shim receptacle that is defined by an orthodontic bracket and to generate a modifying force that alters the corrective force that is applied to the tooth, wherein the orthodontic bracket defines an archwire slot that is sized to receive an archwire, wherein the orthodontic bracket attaches to the tooth and applies the corrective force to the tooth when the archwire is received and operatively secured within the archwire slot, and further wherein the plurality of prescription-altering shims includes a plurality of shim body shapes that generate a plurality of different modifying forces when the shim body is received and operatively secured within the prescription-altering shim receptacle.

D2. The kit of paragraph D1, wherein the plurality of prescription-altering shims includes the prescription-altering shim of any of paragraphs A1-A38.

D3. The kit of any of paragraphs D1-D2, wherein the kit further includes the orthodontic bracket, optionally wherein the orthodontic bracket includes the orthodontic bracket of any of paragraphs B1-B8, and further optionally wherein the kit includes a plurality of orthodontic brackets.

D4. The kit of any of paragraphs D1-D3, wherein the kit further includes the archwire, and optionally wherein the kit includes a plurality of archwires.

D5. The kit of any of paragraphs D1-D4, wherein the plurality of prescription-altering shims and the orthodontic bracket are included in the orthodontic bracket assembly of any of paragraphs C1-C13.

D6. The kit of any of paragraphs D1-D5, wherein the orthodontic bracket assembly includes the orthodontic bracket assembly of any of paragraphs C1-C13.

E1. A prescription-altering cap that is configured to be operatively secured to an orthodontic bracket, wherein the orthodontic bracket includes a base and defines an archwire slot that is sized to receive an archwire, and further wherein the orthodontic bracket is configured to be attached to a tooth and to apply a corrective force to the tooth when the archwire is received and operatively secured within the archwire slot, the prescription-altering cap comprising:

a cap body;

a cap retention structure that operatively secures the cap body to at least one of the orthodontic bracket, a base of the orthodontic bracket, a ligating structure of the orthodontic bracket, and the archwire that is received within the archwire slot of the orthodontic bracket; and

a protrusion that applies a modifying force to the archwire, wherein the modifying force alters the corrective force that is applied to the tooth by the orthodontic bracket when the prescription-altering cap is operatively secured to the orthodontic bracket and the archwire is received and operatively secured within the archwire slot.

E2. The prescription-altering cap of paragraph E1, wherein the modifying force includes at least one of a step modifying force, a tip modifying force, a torque modifying force, and a rotation modifying force.

E3. An orthodontic bracket assembly, comprising:

an orthodontic bracket; and

the prescription-altering cap of any of paragraphs E1-E2.

E4. The orthodontic bracket assembly of paragraph E3, wherein the orthodontic bracket assembly further includes at least one of the archwire and a ligating structure.

F1. A kit of components configured to be utilized to apply a corrective force to a tooth, the kit comprising:

a plurality of prescription-altering caps, wherein the plurality of prescription-altering caps includes the prescription-altering cap of any of paragraphs E1-E2, wherein a first portion of the plurality of prescription-altering caps generates a first modifying force when attached to the orthodontic bracket, wherein a second portion of the plurality of prescription-altering caps generates a second modifying force when attached to the orthodontic bracket, and further wherein the first modifying force is different from the second modifying force, optionally wherein the first modifying force includes a different magnitude than the second modifying force, optionally wherein the first modifying force includes a different direction than the second modifying force, and further optionally wherein the first modifying force includes one of a step modifying force, a tip modifying force, a torque modifying force, and a rotation modifying force and the second modifying force includes another of the step modifying force, the tip modifying force, the torque modifying force, and the rotation modifying force.

G1. An orthodontic bracket assembly, comprising:

an orthodontic bracket, wherein the orthodontic bracket defines an archwire slot that is sized to receive an archwire, and further wherein the orthodontic bracket attaches to a tooth and applies a corrective force to the tooth when the archwire is received and operatively secured within the archwire slot; and

insert means to selectively alter the corrective force that is applied to the tooth by the orthodontic bracket.

G2. The orthodontic bracket assembly of paragraph G1, wherein the orthodontic bracket further includes a prescription-altering shim receptacle.

G3. The orthodontic bracket assembly of any of paragraphs G1-G2 wherein the orthodontic bracket includes the orthodontic bracket of any of paragraphs B1-B8.

G4. The orthodontic bracket assembly of any of paragraphs G1-G3, wherein the insert means includes a shim means for being inserted into a/the prescription-altering shim receptacle of the orthodontic bracket to generate a modifying force that alters the corrective force.

G5. The orthodontic bracket assembly of paragraph G4, wherein the shim means includes a prescription-altering shim, wherein the prescription-altering shim includes a shim body that is sized to be received within a/the prescription-altering shim receptacle, to separate a portion of the orthodontic bracket from a portion of the archwire, and to generate a modifying force that alters the corrective force.

G6. The orthodontic bracket assembly of any of paragraphs G4-G5, wherein the prescription-altering shim includes the prescription-altering shim of any of paragraphs A1-A47.

G7. The orthodontic bracket assembly of any of paragraphs G1-G6, wherein the means to modify includes a cap means for attaching to at least one of the orthodontic bracket, a base of the orthodontic bracket, a ligating structure of the orthodontic bracket, and an archwire that is received within the archwire slot of the orthodontic bracket to generate a modifying force that alters the corrective force.

G8. The orthodontic bracket assembly of paragraph G7, wherein the cap means includes a prescription-altering cap, wherein the prescription-altering cap includes the prescription-altering cap of any of paragraphs E1-E2.

H1. A method of altering a corrective force that is applied to a tooth by an orthodontic bracket assembly that includes an orthodontic bracket and a prescription-altering shim, wherein the orthodontic bracket defines an archwire slot that is sized to receive an archwire, and further wherein the orthodontic bracket includes a prescription-altering shim receptacle, the method comprising:

inserting the prescription-altering shim into the prescription-altering shim receptacle to generate a modifying force, wherein the modifying force alters the corrective force, and further wherein the inserting includes inserting at least a portion of the prescription-altering shim between a portion of the orthodontic bracket and a portion of the archwire.

H2. The method of paragraph H1, wherein, prior to the inserting, the method further includes selecting the prescription-altering shim from a plurality of prescription-altering shims, and optionally wherein the plurality of prescription-altering shims define a plurality of different modifying forces when inserted into the prescription-altering shim receptacle.

H3. The method of paragraph H2, wherein the selecting includes selecting based upon a difference between a current corrective force that is being applied to the tooth by the orthodontic bracket and a target corrective force that is desired to be applied to the tooth by the orthodontic bracket.

H4. The method of any of paragraphs H1-H3, wherein the inserting includes inserting the prescription-altering shim after the archwire has been received within the archwire slot and optionally after the archwire has been operatively secured within the archwire slot.

H5. The method of any of paragraphs H1-H4, wherein the method further includes receiving the archwire within the archwire slot, optionally wherein the method includes the receiving prior to the inserting.

H6. The method of any of paragraphs H1-H5, wherein the method further includes operatively securing the archwire within the archwire slot, optionally wherein the operatively securing is performed subsequent to the inserting, optionally wherein the operatively securing is performed prior to the inserting, and further optionally wherein the method includes unsecuring the archwire prior to the inserting and the operatively securing.

H7. The method of any of paragraphs H1-H6, wherein the method further includes displacing the archwire from the archwire slot, optionally wherein the displacing is performed prior to the inserting, and further optionally wherein the method includes operatively securing the archwire within the archwire slot subsequent to the inserting.

H8. The method of any of paragraphs H1-H7, wherein the inserting includes at least one of displacing and deflecting the archwire.

H9. The method of any of paragraphs H1-H8, wherein the prescription-altering shim is a first prescription-altering shim that generates a first modifying force, and further wherein the method includes inserting a second prescription-altering shim to generate a second modifying force.

H10. The method of any of paragraphs H1-H9, wherein the orthodontic bracket includes the orthodontic bracket of any of paragraphs B1-B15.

H11. The method of any of paragraphs H1-H10, wherein the prescription-altering shim includes the prescription-altering shim of any of paragraphs A1-A47.

H12. The method of any of paragraphs H1-H11, wherein the orthodontic bracket and the prescription-altering shim form a portion of the orthodontic bracket assembly of any of paragraphs C1-C13 or G1-G8 or the kit of any of paragraphs D1-D6.

I1. A method of altering a corrective force that is applied to a tooth by an orthodontic bracket assembly that includes an orthodontic bracket, wherein the orthodontic bracket defines an archwire slot that is sized to receive an archwire, the method comprising:

attaching a prescription-altering cap to the orthodontic bracket, wherein the prescription-altering cap engages the archwire and applies a modifying force to the archwire, and further wherein the modifying force alters the corrective force that is applied to the tooth by the orthodontic bracket assembly.

I2. The method of paragraph I1, wherein the attaching includes attaching to at least one of a base of the orthodontic bracket, a ligating structure of the orthodontic bracket, and the archwire that is received in the archwire slot.

I3. The method of any of paragraphs I1-I2, wherein, prior to the attaching, the method further includes selecting the prescription-altering cap from a plurality of prescription-altering caps, and optionally wherein the plurality of prescription-altering caps define a plurality of different modifying forces when attached to the orthodontic bracket.

I4. The method of paragraph I3, wherein the selecting includes selecting based upon a difference between a current corrective force that is being applied to the tooth by the orthodontic bracket and a target corrective force that is desired to be applied to the tooth by the orthodontic bracket.

I5. The method of any of paragraphs I1-I4, wherein the prescription-altering cap includes the prescription-altering cap of any of paragraphs E1-E2.

J1. The use of any of the prescription-altering shims of any of paragraphs A1-A47, any of the orthodontic brackets of any of paragraphs B1-B15, any of the orthodontic bracket assemblies of any of paragraphs C1-C13 or G1-G8, or any of the kits of any of paragraphs D1-D6 with any of the methods of any of paragraphs H1-H12.

J2. The use of any of the methods of any of paragraphs H1-H12 with any of the prescription-altering shims of any of paragraphs A1-A47, any of the orthodontic brackets of any of paragraphs B1-B15, any of the orthodontic bracket assemblies of any of paragraphs C1-C13 or G1-G8, or any of the kits of any of paragraphs D1-D6.

J3. The use of any of the prescription-altering caps of any of paragraphs E1-E2, any of the orthodontic bracket assemblies of any of paragraphs E3-E4, or the kit of paragraph F1 with the method of any of paragraphs I1-I5.

J4. The use of any of the methods of any of paragraphs I1-I5 with any of the prescription-altering caps of any of paragraphs E1-E2, any of the orthodontic bracket assemblies of any of paragraphs E3-E4, or the kit of paragraph F1.

J5. The use of a prescription-altering shim to generate a modifying force that alters a corrective force that is applied to a tooth by an orthodontic bracket assembly, optionally wherein the prescription-altering shim includes the prescription-altering shim of any of paragraphs A1-A47, and further optionally wherein the orthodontic bracket assembly includes the orthodontic bracket assembly of any of paragraphs C1-C13.

J6. The use of a prescription-altering cap to generate a modifying force that alters a corrective force that is applied to a tooth by an orthodontic bracket assembly, optionally wherein the prescription-altering cap includes the prescription-altering cap of any of paragraphs E1-E2, and further optionally wherein the orthodontic bracket assembly includes the orthodontic bracket assembly of any of paragraphs E3-E4.

### INDUSTRIAL APPLICABILITY

The prescription-altering accessories and orthodontic bracket assemblies disclosed herein are applicable to the orthodontic field.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. An orthodontic bracket assembly, comprising:
an orthodontic bracket, wherein the orthodontic bracket includes a bracket body, wherein the bracket body defines an archwire slot that is sized to receive an archwire, wherein the bracket body further defines a bracket base that attaches to a tooth and applies a corrective force to the tooth when the archwire is received and operatively secured within the archwire slot, and further wherein the bracket body includes a prescription-altering shim receptacle; and
a prescription-altering shim, wherein the prescription-altering shim includes a shim body, wherein the shim body is received and operatively secured within the prescription-altering shim receptacle and separates a portion of the orthodontic bracket from a portion of the archwire, and further wherein the shim body generates a modifying force that alters the corrective force that is applied to the tooth by the orthodontic bracket when the archwire is received and operatively secured within the archwire slot.

2. The orthodontic bracket assembly of claim 1, wherein the orthodontic bracket assembly further includes the archwire.

3. The orthodontic bracket assembly of claim 1, wherein the orthodontic bracket assembly includes a plurality of orthodontic brackets, wherein each of the plurality of orthodontic brackets defines a respective archwire slot, wherein the archwire is received in each of the respective archwire slots, and further wherein each of the plurality of orthodontic brackets defines a respective prescription-altering shim receptacle that is sized to receive a respective prescription-altering shim.

4. The orthodontic bracket assembly of claim 1, wherein the orthodontic bracket defines a plurality of prescription-altering shim receptacles, and further wherein the plurality of prescription-altering shim receptacles includes at least a first prescription-altering shim receptacle and a second prescription-altering shim receptacle.

5. The orthodontic bracket assembly of claim 4, wherein the plurality of prescription-altering shim receptacles includes at least one of a plurality of spaced-apart prescription-altering shim receptacles and a plurality of discrete prescription-altering shim receptacles.

6. The orthodontic bracket assembly of claim 4, wherein the prescription-altering shim is a first prescription-altering shim that is received within the first prescription-altering shim receptacle, and further wherein the orthodontic bracket assembly includes a second prescription-altering shim that is received within the second prescription-altering shim receptacle, wherein the first prescription-altering shim generates a first modifying force, wherein the second prescription-altering shim generates a second modifying force, and further wherein a total modifying force includes the first modifying force and the second modifying force.

7. The orthodontic bracket assembly of claim 1, wherein an orthodontic bracket-contacting portion of the shim body is in mechanical contact with the orthodontic bracket and an archwire-contacting portion of the shim body is in mechanical contact with the archwire, wherein the orthodontic bracket applies a bracket force to the orthodontic bracket-contacting portion of the shim body, and further wherein the archwire applies an opposed archwire force to the archwire-contacting portion of the shim body when the archwire is received and operatively secured within the archwire slot.

8. The orthodontic bracket assembly of claim 1, wherein the shim body modifies a shape of at least a portion of the archwire slot.

9. The orthodontic bracket assembly of claim 1, wherein the shim body generates at least one of a step modifying force, a tip modifying force, a torque modifying force, and a rotational modifying force when the archwire is received and operatively secured within the archwire slot.

10. The orthodontic bracket assembly of claim 1, wherein the shim body is an elongate shim body that defines a shim longitudinal direction, and further wherein the shim longitudinal direction is within 15 degrees of being parallel to an archwire longitudinal direction.

11. The orthodontic bracket assembly of claim 1, wherein the shim body is an elongate shim body that defines a shim longitudinal direction, wherein the archwire defines an archwire longitudinal direction that is defined by a portion of the archwire that is received within the archwire slot, wherein the tooth defines a tooth longitudinal direction, wherein the shim longitudinal direction is within 15 degrees of being perpendicular to the archwire longitudinal direction, wherein the shim longitudinal direction is within 15 degrees of being perpendicular to the tooth longitudinal direction, and further wherein the shim body contacts at least one of a gum-proximal face of the archwire and a gum-distal face of the archwire.

12. The orthodontic bracket assembly of claim 1, wherein the shim body is an elongate shim body that defines a shim longitudinal direction, wherein the archwire defines an archwire longitudinal direction that is defined by a portion of the archwire that is received within the archwire slot, wherein the tooth defines a tooth longitudinal direction, wherein the shim longitudinal direction is within 15 degrees of being perpendicular to the archwire longitudinal direction, wherein the shim longitudinal direction is within 15 degrees of being parallel to the tooth longitudinal direction, and further wherein the shim body contacts at least one of a tooth-proximal face of the archwire and a tooth-distal face of the archwire.

13. The orthodontic bracket assembly of claim 1, wherein the shim body includes a substantially constant transverse cross-sectional shape.

14. The orthodontic bracket assembly of claim 1, wherein the shim body includes a tapered profile.

15. The orthodontic bracket assembly of claim 1, wherein the prescription-altering shim includes an extension region that is not contained within the prescription-altering shim receptacle, wherein the extension region generates a portion of the modifying force.

16. The orthodontic bracket assembly of claim 15, wherein the extension region extends to contact a portion of the archwire that is not received within the archwire slot and to deflect the portion of the archwire that is not received within the archwire slot to generate the portion of the modifying force.

17. The orthodontic bracket assembly of claim 15, wherein the extension region includes a tooth-contacting portion that contacts the tooth, and further wherein the tooth-contacting portion applies an extension region corrective force to the tooth to generate the portion of the modifying force.

18. The orthodontic bracket assembly of claim 1, wherein the archwire slot defines at least a majority of the prescription-altering shim receptacle.

19. The orthodontic bracket assembly of claim 1, wherein the archwire slot defines a fraction of the prescription-altering shim receptacle, wherein the fraction of the prescription-altering shim receptacle includes at least 5% and less than 50% of the prescription-altering shim receptacle.

20. A kit of components configured to be utilized to apply a corrective force to a tooth, the kit comprising:
a plurality of prescription-altering shims, wherein each of the plurality of prescription-altering shims is sized to be received within a prescription-altering shim receptacle that is defined by an orthodontic bracket and to generate a modifying force that alters the corrective force that is applied to the tooth, wherein the orthodontic bracket defines an archwire slot that is sized to receive an archwire, wherein the orthodontic bracket attaches to the tooth and applies the corrective force to the tooth when the archwire is received and operatively secured within the archwire slot, and further wherein the plurality of prescription-altering shims includes a plurality of shim body shapes that generate a plurality of different modifying forces when the shim body is received and operatively secured within the prescription-altering shim receptacle.

21. The kit of claim 20, wherein the kit further includes the orthodontic bracket.

22. The kit of claim 20, wherein the kit further includes the archwire.

23. A method of altering a corrective force that is applied to a tooth by an orthodontic bracket assembly that includes an orthodontic bracket and a prescription-altering shim, wherein the orthodontic bracket defines an archwire slot that is sized to receive an archwire, and further wherein the orthodontic bracket includes a prescription-altering shim receptacle, the method comprising:
inserting the prescription-altering shim into the prescription-altering shim receptacle to generate a modifying force, wherein the modifying force alters the corrective force, and further wherein the inserting results in at least a portion of the prescription-altering shim extending between a portion of the orthodontic bracket and a portion of the archwire when the archwire is received and operatively secured within the archwire slot.

24. The method of claim 23, wherein, prior to the inserting, the method further includes selecting the prescription-altering shim from a plurality of prescription-altering shims, wherein the plurality of prescription-altering shims define a plurality of different modifying forces when inserted into the prescription-altering shim receptacle, and further wherein the selecting includes selecting based upon a difference between a current corrective force that is being applied to the tooth by the orthodontic bracket and a target corrective force that is desired to be applied to the tooth by the orthodontic bracket.

25. The method of claim 23, wherein the inserting includes inserting the prescription-altering shim after the archwire has been received within the archwire slot.

26. The method of claim 23, wherein the method further includes receiving the archwire within the archwire slot prior to the inserting.

27. The method of claim 23, wherein the method further includes displacing the archwire from the archwire slot prior to the inserting and operatively securing the archwire within the archwire slot subsequent to the inserting.
